(19) United States
(12) Patent Application Publication
(10) Pub. No.: US 2024/0280787 A1
(43) Pub. Date: Aug. 22, 2024

(54) OPTICAL SYSTEM AND CAMERA MODULE COMPRISING SAME

(71) Applicant: LG INNOTEK CO., LTD., Seoul (KR)

(72) Inventor: Duk Keun KWON, Seoul (KR)

(21) Appl. No.: 18/569,908

(22) PCT Filed: Jun. 17, 2022
(86) PCT No.: PCT/KR2022/008629

§ 371 Date: Dec. 13, 2023

(30) Foreign Application Priority Data
Jun. 18, 2021 (KR) 10-2021-0079380

(51) Int. Cl. G02B 9/64; G02B 13/00; H04N 23/55

(52) U.S. Cl. CPC G02B 9/64; G02B 13/0045; H04N 23/55

(57) ABSTRACT

The optical system disclosed in the embodiment includes first to ninth lenses disposed along an optical axis in a direction from an object side to a sensor side, wherein the first and eighth lenses have positive (+) refractive power on the optical axis, and the second lens, ninth lens has a negative refractive power on the optical axis, L7_CT is a thickness of the seventh lens on the optical axis, L8_CT is a thickness on the optical axis of the eighth lens, wherein the following equation satisfies: 0.1<L7_CT/L8_CT<0.8.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses. In addition, the size of the image sensor is increasing to realize high-resolution and high-definition. However, when the size of the image sensor increases, the TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. The embodiment provides an optical system having excellent optical performance at the center portion and periphery portion of the angle of view. The embodiment provides an optical system capable of having a slim structure.

### Technical Solution

An optical system according to an embodiment of the invention includes first to ninth lenses disposed along an optical axis in a direction from an object side to a sensor side, wherein the first lens has positive (+) refractive power on the optical axis, and the second lens has negative (−) refractive power on the optical axis, the eighth lens has positive (+) refractive power on the optical axis, and the ninth lens has negative (−) refractive power on the optical axis, L7_CT is a thickness on the optical axis of the seventh lens, L8_CT is a thickness on the optical axis of the eighth lens, and the following equation may satisfy: 0.1<L7_CT/L8_CT<0.8.

According to an embodiment of the invention, F means the total focal length (mm) of the optical system, f1 means the focal length (mm) of the first lens, and the following equation may satisfy: 0.5<f1/F<2.

According to an embodiment of the invention, L8_CT is a thickness on the optical axis of the eighth lens, L8_ET is a thickness in a direction of the optical axis at the end of the effective region of the eighth lens, and the following equation may satisfy: 0.2<L8_ET/L8_CT<0.8.

According to an embodiment of the invention, a sensor-side surface of the eighth lens may have a convex shape on the optical axis. An object-side surface of the first lens may have a convex shape on the optical axis, and the sensor-side surface of the second lens may have a concave shape on the optical axis.

An optical system according to an embodiment of the invention includes first to ninth lenses disposed along an optical axis in a direction from an object side to a sensor side, wherein the first lens has positive (+) refractive power on the optical axis, the second lens has negative (−) refractive power on the optical axis, the eighth lens has positive (+) refractive power on the optical axis, and the ninth lens has negative (−) refractive power on the optical axis, wherein a sensor-side surface of the ninth lens includes a first critical point, and the first critical point is disposed in a range of about 40% to about 60% of an effective radius of the sensor-side surface of the ninth lens with respect to the optical axis.

According to an embodiment of the invention, the object-side surface of the seventh lens includes a second critical point, and the second critical point is disposed in a range of 60% to 80% of an effective radius of a object-side surface of the seventh lens with respect to the optical axis.

According to an embodiment of the invention, a sensor-side surface of the seventh lens includes a third critical point, and the third critical point is disposed in a range of 55% to 75% of an effective radius of a sensor-side surface of the seventh lens with respect to the optical axis.

According to an embodiment of the invention, a distance from the optical axis to the first critical point may be smaller than a distance from the optical axis to the second critical point.

An optical system according to an embodiment of the invention includes first to ninth lenses disposed along an optical axis in a direction from an object side to a sensor side, wherein the first lens has positive (+) refractive power on the optical axis, the second lens has negative (−) refractive power on the optical axis, the eighth lens has positive (+) refractive power on the optical axis, and the ninth lens has negative (−) refractive power on the optical axis, wherein the sixth and seventh lenses are spaced apart by a first distance in a direction of the optical axis, and the first distance increases from the optical axis toward a first point located on the sensor-side surface of the sixth lens and decreases from the first point toward the second point located on the sensor-side surface of the sixth lens, and the second point is disposed more outside than the first point from the optical axis.

According to an embodiment of the invention, the first point is disposed in the range of 65% to 85% of the effective radius of the sensor-side surface of the sixth lens with respect to the optical axis. The second point is an end or edge of the effective region of the sensor-side surface of the sixth lens.

According to an embodiment of the invention, the seventh and eighth lenses are spaced apart by a second distance in a direction of the optical axis, and the second distance decreases from the optical axis toward a third point located on the sensor-side surface of the seventh lens, and the third point is an end of the effective region of the sensor-side surface of the seventh lens.

According to an embodiment of the invention, the eighth and ninth lenses are spaced apart by a third distance in a direction of the optical axis, and the third distance increases from the optical axis toward a fourth point located on the sensor-side surface of the eighth lens, and decreases from the fourth point toward a fifth point located on the sensor-side surface of the eighth lens, and the fifth point is disposed more outside than the fourth point with respect to the optical axis. The third distance increases from the fifth point toward a sixth point located on the sensor-side surface of the eighth lens, and the sixth point is an end of the effective region of the sensor-side surface of the eighth lens.

A camera module according to an embodiment of the invention includes an optical system and an image sensor, the optical system includes the optical system disclosed above, and a total track length (TTL) means a distance on the optical axis from a vertex of the object-side surface of the first lens to an upper surface of an image sensor, and the following equation may satisfy: 2<TTL<20.

### Advantageous Effects

The optical system and the camera module according to the embodiment may have improved optical properties. In detail, the optical system may have improved resolution as a plurality of lenses have a set shape, focal length, and the like. The optical system and the camera module according to the embodiment may have improved distortion and aberration characteristics, and may have good optical performance at the center portion and periphery portion of the field of view (FOV). The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system according to a first embodiment.

FIG. 2 is a graph showing an aberration diagram of the optical system according to the first embodiment.

FIG. 3 is a view showing a distortion grid of the optical system according to the first embodiment.

FIG. 4 is a graph showing coma aberration of the optical system according to the first embodiment.

FIG. 5 is a configuration diagram of an optical system according to a second embodiment.

FIG. 6 is a graph showing an aberration diagram of an optical system according to the second embodiment.

FIG. 7 is a view showing a distortion grid of an optical system according to a second embodiment.

FIG. 8 is a graph showing coma aberration of the optical system according to the second embodiment.

FIG. 9 is a block diagram of an optical system according to the third embodiment.

FIG. 10 is a graph showing an aberration diagram of an optical system according to the third embodiment.

FIG. 11 is a diagram for a distortion grid of an optical system according to a third embodiment.

FIG. 12 is a view showing a coma aberration of the optical system according to the third embodiment.

FIG. 13 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C.

In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”. “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

“Object-side surface” may refer to a surface of the lens facing the object-side surface with respect to the optical axis, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. The radius of curvature, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes.

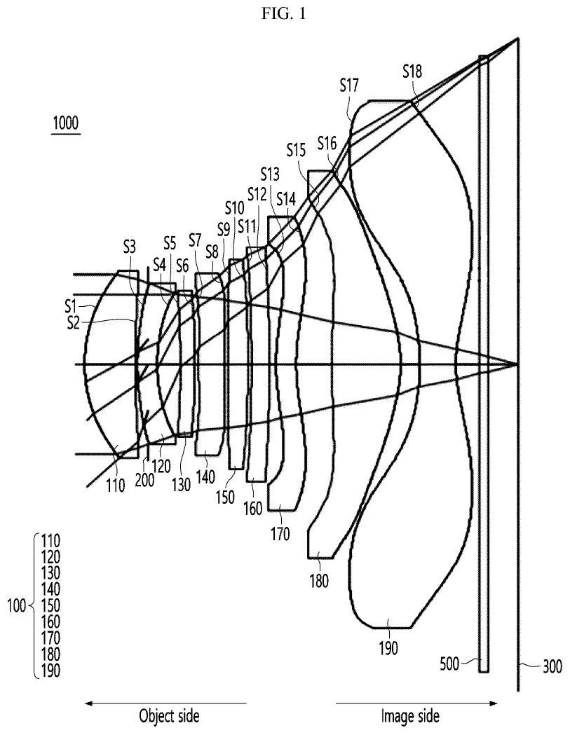

FIGS. 1, 5, and 9 are views illustrating an optical system and a camera module having the same according to embodiments.

Referring to FIGS. 1, 5 and 9, the optical system 1000 according to the embodiment may include a plurality of lenses 100 and an image sensor 300. For example, the optical system 1000 may include five or more lenses. In detail, the optical system 1000 may include eight or more lenses. The optical system 1000 may include nine lenses. The optical system 1000 may include the first lens 110 to the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. The light corresponding to the object information may pass through the first lens 110 to the ninth lens 190 and be incident on the image sensor 300. Each of the plurality of lenses 100 may include an effective region and an ineffective region. The effective region may be a region through which light incident on each of the first to ninth lenses 110, 120, 130, 140, 150, 160, 170, 180 and 190 passes. That is, the effective region may be a region in which incident light is refracted to realize optical properties, and may be expressed as an effective diameter. The ineffective region may be disposed around the effective region. The ineffective region may be a region to which light is not incident from the plurality of lenses 100. That is, the ineffective region may be a region independent of the optical characteristic. Also, the ineffective region may be a region fixed to a barrel (not shown) for accommodating the lens.

The image sensor 300 may sense light. In detail, the image sensor 300 may detect light sequentially passing through the plurality of lenses 100, in detail, the first to ninth lenses 110, 120, 130, 140, 150, 160, 170, 180 and 190. The image sensor 300 may include a device capable of detecting incident light, such as a charge coupled device (CCD) or a complementary metal oxide semiconductor (CMOS).

The optical system 1000 according to the embodiment may further include a filter 500. The filter 500 may be disposed between the plurality of lenses 100 and the image sensor 300. The filter 500 may be disposed between the image sensor 300 and the last lens disposed closest to the image sensor 300 among the plurality of lenses 100. For example, when the optical system 1000 includes nine lenses, the filter 500 may be disposed between the ninth lens 190 and the image sensor 300. The filter 500 may include at least one of an infrared filter and an optical filter such as a cover glass. The filter 500 may pass light of a set wavelength band and filter light of a different wavelength band. When the filter 500 includes an infrared filter, radiant heat emitted from external light may be blocked from being transmitted to the image sensor 300. In addition, the filter 500 may transmit visible light and reflect infrared light.

The optical system 1000 according to the embodiment may include an aperture stop (not shown). The aperture stop may control the amount of light incident on the optical system 1000. The aperture stop may be disposed at a set position. For example, the aperture stop may be located on front side of the first lens 110 or may be located on a rear side of the first lens 110. Also, the aperture stop may be disposed between two lenses selected from among the plurality of lenses 100. For example, the aperture stop may be positioned between the first lens 110 and the second lens 120. Alternatively, at least one lens selected from among the plurality of lenses 100 may serve as an aperture stop. In detail, the object-side surface or sensor-side surface of one lens selected from among the first to ninth lenses 110, 120, 130, 140, 150, 160, 170, 180, 190 may serve as an aperture stop for controlling the amount of light. For example, the sensor-side surface (second surface S2) of the first lens 110 or the object-side surface (third surface S3) of the second lens 120 may serve as an aperture stop.

The optical system 1000 may include at least one light path changing member (not shown). The light path changing member may change the path of the light by reflecting the light incident from the outside. The light path changing member may include a reflector and a prism. For example, the light path changing member may include a right-angled prism. When the light path changing member includes a right-angle prism, the light path changing member may change the path of the light by reflecting the path of the incident light at an angle of 90 degrees. The light path changing member may be disposed closer to the object side than the plurality of lenses 100. That is, when the optical system 1000 includes one light path changing member, the optical path changing member, the first lens 110, the second lens 120, and the third lens 130, the fourth lens 140, the fifth lens 150, the sixth lens 160, the seventh lens 170, the eighth lens 180, the ninth lens 190, the filter 500 and the image sensors 300 may be arranged in order from the object side to the sensor direction. Alternatively, the light path changing member may be disposed between the plurality of lenses 100. For example, the light path changing member may be disposed between an nth lens and an n+1th lens. Alternatively, the light path changing member may be disposed between the plurality of lenses 100 and the image sensor 300. The light path changing member may change a path of light incident from the outside in a set direction. For example, when the optical path changing member is disposed closer to the object side than the plurality of lenses 100, the optical path changing member may change a path of the light incident on the optical path changing member in the first direction to the plurality of lenses to a second direction (a direction of the optical axis OA of the drawing in a direction in which a plurality of lenses 100 are spaced apart) that is an arrangement direction of the plurality of lenses 100. When the optical system 1000 includes a light path changing member, the optical system may be applied to a folded camera capable of reducing the thickness of the camera.

In detail, when the optical system 1000 includes the light path changing member, light incident in a direction perpendicular to the surface of the device to which the optical system 1000 is applied may be changed in a direction parallel to the surface of the device. Accordingly, the optical system 1000 including the plurality of lenses 100 may have a thinner thickness in the device, and thus the device may be provided thinner. For example, when the optical system 1000 does not include the light path changing member, the plurality of lenses 100 may be disposed to extend in a direction perpendicular to the surface of the device in the device. Accordingly, the optical system 1000 including the plurality of lenses 100 has a high height in a direction perpendicular to the surface of the device, and therefore, it may be difficult to form a thin thickness of the optical system 1000 and a device including the same. However, when the optical system 1000 includes the light path changing member, the plurality of lenses 100 may be disposed to extend in a direction parallel to the surface of the device. That is, the optical system 1000 is disposed so that the optical axis OA is parallel to the surface of the device, and may be applied to a folded camera. Accordingly, the optical system 1000 including the plurality of lenses 100 may have a low height in a direction perpendicular to the surface of the device. Accordingly, the camera including the optical system 1000 may have a thin thickness in the device, and the thickness of the device may also be reduced.

Hereinafter, the plurality of lenses 100 according to the embodiment will be described in more detail.

Referring to FIGS. 1, 5, and 9, the first lens 110 may have a positive (+) refractive power on the optical axis OA. The first lens 110 may include a plastic or glass material. For example, the first lens 110 may be made of a plastic material. The first lens 110 may include a first surface S1 defined as an object-side surface and a second surface S2 defined as a sensor-side surface. The first surface S1 may have a convex shape on the optical axis OA, and the second surface S2 may be concave on the optical axis OA. That is, the first lens 110 may have a meniscus shape convex from the optical axis OA toward the object side. Alternatively, the first surface S1 may have a convex shape on the optical axis OA, and the second surface S2 may be convex on the optical axis OA. That is, the first lens 110 may have a shape in which both sides are convex on the optical axis OA. At least one of the first surface S1 and the second surface S2 may be an aspherical surface. For example, both the first surface S1 and the second surface S2 may be aspherical.

The second lens 120 may have negative (−) refractive power on the optical axis OA. The second lens 120 may include a plastic or glass material. For example, the second lens 120 may be made of a plastic material. The second lens 120 may include a third surface S3 defined as an object-side surface and a fourth surface S4 defined as a sensor-side surface. The third surface S3 may be convex on the optical axis OA, and the fourth surface S4 may be concave on the optical axis OA. That is, the second lens 120 may have a meniscus shape convex from the optical axis OA toward the object side. Alternatively, the third surface S3 may be concave on the optical axis OA, and the fourth surface S4 may be concave on the optical axis OA. That is, the second lens 120 may have a concave shape on both sides of the optical axis OA. At least one of the third surface S3 and the fourth surface S4 may be an aspherical surface. For example, both the third surface S3 and the fourth surface S4 may be aspherical.

The third lens 130 may have positive (+) or negative (−) refractive power on the optical axis OA. The third lens 130 may include a plastic or glass material. For example, the third lens 130 may be made of a plastic material. The third lens 130 may include a fifth surface S5 defined as an object-side surface and a sixth surface S6 defined as a sensor-side surface. The fifth surface S5 may be convex on the optical axis OA, and the sixth surface S6 may be concave on the optical axis OA. That is, the third lens 130 may have a meniscus shape convex from the optical axis OA toward the object side. Alternatively, the fifth surface S5 may be convex on the optical axis OA, and the sixth surface S6 may be convex on the optical axis OA. That is, the third lens 130 may have a shape in which both sides are convex on the optical axis OA. Alternatively, the fifth surface S5 may be concave on the optical axis OA, and the sixth surface S6 may be convex on the optical axis OA. That is, the third lens 130 may have a meniscus shape convex from the optical axis OA toward the sensor. Alternatively, the fifth surface S5 may be concave on the optical axis OA, and the sixth surface S6 may be concave on the optical axis OA. That is, the third lens 130 may have a concave shape on both sides of the optical axis OA. At least one of the fifth surface S5 and the sixth surface S6 may be an aspherical surface. For example, both the fifth surface S5 and the sixth surface S6 may be aspherical.

The fourth lens 140 may have positive (+) or negative (−) refractive power on the optical axis OA. The fourth lens 140 may include a plastic or glass material. For example, the fourth lens 140 may be made of a plastic material. The fourth lens 140 may include a seventh surface S7 defined as an object-side surface and an eighth surface S8 defined as a sensor-side surface. The seventh surface S7 may be convex on the optical axis OA, and the eighth surface S8 may be concave on the optical axis OA. That is, the fourth lens 140 may have a meniscus shape convex from the optical axis OA toward the object side. Alternatively, the seventh surface S7 may be convex on the optical axis OA, and the eighth surface S8 may be convex on the optical axis OA. That is, the fourth lens 140 may have a shape in which both sides are convex on the optical axis OA. Alternatively, the seventh surface S7 may be concave on the optical axis OA, and the eighth surface S8 may be convex on the optical axis OA. That is, the fourth lens 140 may have a meniscus shape convex from the optical axis OA toward the sensor side. Alternatively, the seventh surface S7 may be concave on the optical axis OA, and the eighth surface S8 may be concave on the optical axis OA. That is, the fourth lens 140 may have a shape in which both surfaces are concave. At least one of the seventh surface S7 and the eighth surface S8 may be an aspherical surface. For example, both the seventh surface S7 and the eighth surface S8 may be aspherical.

The fifth lens 150 may have positive (+) or negative (−) refractive power on the optical axis OA. The fifth lens 150 may include a plastic or glass material. For example, the fifth lens 150 may be made of a plastic material. The fifth lens 150 may include a ninth surface S9 defined as an object-side surface and a tenth surface S10 defined as a sensor-side surface. The ninth surface S9 may be convex on the optical axis OA, and the tenth surface S10 may be concave on the optical axis OA. That is, the fifth lens 150 may have a meniscus shape convex from the optical axis OA toward the object side. Alternatively, the ninth surface S9 may be convex on the optical axis OA, and the tenth surface S10 may be convex on the optical axis OA. That is, the fifth lens 150 may have a shape in which both sides are convex on the optical axis OA. Alternatively, the ninth surface S9 may be concave on the optical axis OA, and the tenth surface S10 may be convex on the optical axis OA. That is, the fifth lens 150 may have a meniscus shape convex from the optical axis OA toward the sensor. Alternatively, the ninth surface S9 may be concave on the optical axis OA, and the tenth surface S10 may be concave on the optical axis OA. That is, the fifth lens 150 may have a concave shape on both sides of the optical axis OA. At least one of the ninth surface S9 and the tenth surface S10 may be an aspherical surface. For example, both the ninth surface S9 and the tenth surface S10 may be aspherical.

The sixth lens 160 may have positive (+) or negative (−) refractive power on the optical axis OA. The sixth lens 160 may include a plastic or glass material. For example, the sixth lens 160 may be made of a plastic material. The sixth lens 160 may include an eleventh surface S11 defined as an object-side surface and a twelfth surface S12 defined as a sensor-side surface. The eleventh surface S11 may be convex on the optical axis OA, and the twelfth surface S12 may be concave on the optical axis OA. That is, the sixth lens 160 may have a meniscus shape convex from the optical axis OA toward the object side. Alternatively, the eleventh surface S11 may be convex on the optical axis OA, and the twelfth surface S12 may be convex on the optical axis OA. That is, the sixth lens 160 may have a shape in which both sides are convex on the optical axis OA. Alternatively, the eleventh surface S11 may be concave on the optical axis OA, and the twelfth surface S12 may be convex on the optical axis OA. That is, the sixth lens 160 may have a meniscus shape convex from the optical axis OA toward the sensor. Alternatively, the eleventh surface S11 may be concave on the optical axis OA, and the twelfth surface S12 may be concave on the optical axis OA. That is, the sixth lens 160 may have a concave shape on both sides of the optical axis OA. At least one of the eleventh surface S11 and the twelfth surface S12 may be an aspherical surface. For example, both the eleventh surface S11 and the twelfth surface S12 may be aspherical.

The seventh lens 170 may have positive (+) or negative (−) refractive power on the optical axis OA. The seventh lens 170 may include a plastic or glass material. For example, the seventh lens 170 may be made of a plastic material. The seventh lens 170 may include a thirteenth surface S13 defined as an object-side surface and a fourteenth surface S14 defined as a sensor-side surface. The thirteenth surface S13 may be convex on the optical axis OA, and the fourteenth surface S14 may be concave on the optical axis OA. That is, the seventh lens 170 may have a meniscus shape convex from the optical axis OA toward the object side. Alternatively, the thirteenth surface S13 may be convex on the optical axis OA, and the fourteenth surface S14 may be convex on the optical axis OA. That is, the seventh lens 170 may have a shape in which both surfaces are convex. Alternatively, the thirteenth surface S13 may be concave on the optical axis OA, and the fourteenth surface S14 may be convex on the optical axis OA. That is, the seventh lens 170 may have a meniscus shape convex from the optical axis OA toward the sensor. Alternatively, the thirteenth surface S13 may be concave on the optical axis OA, and the fourteenth surface S14 may be concave on the optical axis OA, that is, the both sides of the seventh lens 170 may be concave shape on the optical axis OA. At least one of the thirteenth surface S13 and the fourteenth surface S14 may be an aspherical surface. For example, both the thirteenth surface S13 and the fourteenth surface S14 may be aspherical.

The seventh lens 170 may include at least one critical point. In detail, at least one of the thirteenth surface S13 and the fourteenth surface S14 may include a critical point. Here, the critical point may mean a point at which the slope of the tangent to the lens surface is 0. In detail, the critical point is a point at which the sign of the inclination value with respect to the optical axis OA and the direction perpendicular to the optical axis OA changes from positive (+) to negative (−) or from negative (−) to positive (+), and may mean a point at which the slope value is 0. The tangent line at the critical point may be perpendicular to the optical axis OA. For example, the thirteenth surface S13 may include a first critical point (not shown) defined as a critical point. The first critical point may be positioned at about 80% or less when the optical axis OA is the starting point and the effective region end of the thirteenth surface S13 of the seventh lens 170 is the end point. In detail, the first critical point may be disposed in the range of about 60% to about 80% when the optical axis OA is the starting point and the effective region end of the thirteenth surface S13 of the seventh lens 170 is the endpoint. In more detail, the first critical point may be disposed in the range of about 65% to about 75% when the optical axis OA is the starting point and the effective region end of the thirteenth surface S13 of the seventh lens 170 is the endpoint. Here, the position of the first critical point is a position set based on a direction perpendicular to the optical axis OA, and may mean a linear distance from the optical axis OA to the first critical point. The fourteenth surface S14 may include a second critical point (not shown) defined as a critical point. When the optical axis OA is the starting point and the effective region end of the fourteenth surface S14 of the seventh lens 170 is the end point, the second critical point may be positioned at about 75% or less of the effective radius of the fourteenth surface S14 with respect to the optical axis OA. In detail, the second critical point may be disposed in a range of about 55% to about 75% of an effective radius of the fourteenth surface S14 with respect to the optical axis. In more detail, the second critical point may be disposed in a range of about 60% to about 70% of an effective radius of the fourteenth surface S14 of the seventh lens 170 with respect to the optical axis OA. Here, the position of the second critical point is a position set based on a direction perpendicular to the optical axis OA, and may mean a straight-line distance from the optical axis OA to the second critical point.

The positions of the first critical point and the second critical point are preferably arranged at positions satisfying the above-described ranges in consideration of optical characteristics of the optical system 1000. In detail, the positions of the first and second critical points preferably satisfy the above-described ranges for controlling optical characteristics such as aberration characteristics and resolving power of the optical system 1000. A distance between the first and second critical points in the optical axis OA based on a direction perpendicular to the optical axis OA may be different from each other. In detail, a distance from the optical axis OA to the first critical point may be smaller than a distance from the optical axis OA to the second critical point. For example, the distance from the optical axis OA to the first critical point may be less than or equal to about 90% of the distance from the optical axis OA to the second critical point. Preferably, the distance from the optical axis OA to the first critical point may be in a range of about 70% to about 90% of the distance from the optical axis OA to the second critical point in consideration of optical characteristics of the periphery portion of the FOV. Accordingly, the optical system 1000 according to the embodiment can effectively control light in a region corresponding to the peripheral portion of the field of view (FOV), and thus may have improved optical characteristics not only in the center portion but also in the peripheral portion of the field of view (FOV).

The eighth lens 180 may have positive (+) refractive power on the optical axis OA. The eighth lens 180 may include a plastic or glass material. For example, the eighth lens 180 may be made of a plastic material. The eighth lens 180 may include a fifteenth surface S15 defined as an object-side surface and a sixteenth surface S16 defined as a sensor-side surface. The fifteenth surface S15 may be convex on the optical axis OA, and the sixteenth surface S16 may be convex on the optical axis OA. That is, the eighth lens 180 may have a shape in which both surfaces are convex. Alternatively, the fifteenth surface S15 may be concave on the optical axis OA, and the sixteenth surface S16 may be convex on the optical axis OA. That is, the eighth lens 180 may have a meniscus shape convex toward the sensor side. At least one of the fifteenth surface S15 and the sixteenth surface S16 may be an aspherical surface. For example, both the fifteenth surface S15 and the sixteenth surface S16 may be aspherical.

The ninth lens 190 may have negative (−) refractive power on the optical axis OA. The ninth lens 190 may include a plastic or glass material. For example, the ninth lens 190 may be made of a plastic material. The ninth lens 190 may include a seventeenth surface S17 defined as an object-side surface and an eighteenth surface S18 defined as a sensor-side surface. The seventeenth surface S17 may be convex on the optical axis OA, and the eighteenth surface S18 may be concave on the optical axis OA. That is, the ninth lens 190 may have a meniscus shape convex toward the object side from the optical axis OA. Alternatively, the seventeenth surface S17 may be convex on the optical axis OA, and the eighteenth surface S18 may be convex on the optical axis OA. That is, the ninth lens 190 may have a shape in which both sides are convex on the optical axis OA. Alternatively, the seventeenth surface S17 may be concave on the optical axis OA, and the eighteenth surface S18 may be convex on the optical axis OA. That is, the ninth lens 190 may have a meniscus shape convex from the optical axis OA toward the sensor. Alternatively, the seventeenth surface S17 may be concave on the optical axis OA, and the eighteenth surface S18 may be concave on the optical axis OA. That is, the ninth lens 190 may have a concave shape on both sides of the optical axis OA. At least one of the seventeenth surface S17 and the eighteenth surface S18 may be an aspherical surface. For example, both the seventeenth surface S17 and the eighteenth surface S18 may be aspherical.

The ninth lens 190 may include at least one critical point. In detail, at least one of the seventeenth surface S17 and the eighteenth surface S18 may include a critical point. For example, the eighteenth surface S18 may include a third critical point (not shown) defined as a critical point. When the optical axis OA is the starting point and an end of the effective region of the eighteenth surface S18 of the ninth lens 190 is the end point, the third critical point may be disposed at a position less than or equal to about 60% of the effective radius of the eighteenth surface S18 with respect to the optical axis. In detail, the third critical point may be disposed in a range of about 40% to about 60% of the effective radius of the eighteenth surface S18 with respect to the optical axis. In more detail, the third critical point may be disposed in a range of about 40% to about 50% of the effective radius of the eighteenth surface S18 of the ninth lens 190. Here, the position of the third critical point is a position set based on a direction perpendicular to the optical axis OA, and may mean a straight-line distance from the optical axis OA to the third critical point.

The position of the third critical point is preferably arranged at a position satisfying the above-described range in consideration of the optical characteristics of the optical system 1000. In detail, the position of the third critical point preferably satisfies the above-described range for controlling optical characteristics such as aberration characteristics and resolving power of the optical system 1000. A distance from the optical axis OA to the third critical point based on a direction perpendicular to the optical axis OA may be different from a distance from the optical axis OA to the first and second critical points. In detail, the distance from the optical axis OA to the third critical point may be greater than a distance from the optical axis OA to the first critical point. Also, the distance from the optical axis OA to the third critical point may be greater than a distance from the optical axis OA to the second critical point. Accordingly, the ninth lens 190 may effectively control the path of light emitted to the image sensor 300 through the ninth lens 190. Accordingly, the optical system 1000 according to the embodiment may have improved optical characteristics even at the center portion and periphery portion of the field of view (FOV).

The optical system 1000 according to the embodiment may satisfy at least one or two or more of the following equations. Accordingly, the optical system 1000 according to the embodiment may have improved resolution. In addition, the optical system 1000 may effectively control distortion and aberration characteristics, and may have good optical performance not only at the center portion of the field of view but also at the periphery portion. In addition, the optical system 1000 may have a slimmer and more compact structure.

$$0.5 < f 1 / F < 2 \qquad [ Equation 1 ]$$

In Equation 1, F means a total focal length (mm) of the optical system 1000, and f1 means a focal length (mm) of the first lens 110. When the optical system 1000 according to the embodiment satisfies Equation 1, the optical system 1000 may effectively control incident light and have improved resolution.

$$- 5 < f 1 / f 2 < 0 \qquad [ Equation 2 ]$$

In Equation 2, f1 means a focal length (mm) of the first lens 110, and f2 means a focal length (mm) of the second lens 120. When the optical system 1000 according to the embodiment satisfies Equation 2, the optical system 1000 may have improved resolution.

$$0.5 < f 12 / F < 5 \qquad [ Equation 3 ]$$

In Equation 3, F means the total focal length (mm) of the optical system 1000, and f12 means the combined focal length (mm) from the first lens 110 to the second lens 120. When the optical system 1000 according to the embodiment satisfies Equation 3, the optical system 1000 may effectively control incident light and have improved resolution.

$$0.3 < f 1 / f 12 < 3 \qquad [ Equation 4 ]$$

In Equation 4, f1 means a focal length (mm) of the first lens 110, and f12 means a combined focal length (mm) from the first lens 110 to the second lens 120.

When the optical system 1000 according to the embodiment satisfies Equation 4, the optical system 1000 may have improved resolution.

$$0 < L 1 R 1 / \vert L 1 R 2 \vert < 3 \qquad [ Equation 5 ]$$

In Equation 5, L1R1 means a radius (mm) of curvature on the optical axis OA of the object-side surface (first surface S1) of the first lens 110, and L1R2 means the radius (mm) of curvature on the optical axis OA of the sensor-side surface (second surface S2) of the first lens 110. When the optical system 1000 according to the embodiment satisfies Equation 5, the optical system 1000 may effectively control the incident light, thereby controlling aberration characteristics.

$$0 < L 2 R 2 / \vert L 2 R 1 \vert < 1 \qquad [ Equation 6 ]$$

In Equation 5, L2R1 means a radius (mm) of curvature on the optical axis OA of the object-side surface (third surface S3) of the second lens 120, and L2R2 means a radius (mm) of curvature on the optical axis OA of the sensor-side surface (fourth surface S4) of the second lens 120. When the optical system 1000 according to the embodiment satisfies Equation 6, it is possible to effectively control the light incident on the second lens 120, thereby controlling the aberration characteristics.

$$0.8 < n 1 d / n 2 d < 1.2 \qquad [ Equation 7 ]$$

In Equation 7, n1d means a refractive index at the d-line of the first lens 110, and n2d means a refractive index at the d-line of the second lens 120. When the optical system 1000 according to the embodiment satisfies Equation 7, the viewing angle of the optical system 1000 may be controlled.

$$0.8 < n 8 d / n 7 d < 1.2 \qquad [ Equation 8 ]$$

In Equation 8, n7d means a refractive index at the d-line of the seventh lens 170, and n8d means a refractive index at the d-line of the eighth lens 180. When the optical system 1000 according to the embodiment satisfies Equation 8, the optical system 1000 may obtain good optical performance in the periphery portion of the field of view (FOV). In detail, when the optical system 1000 satisfies Equation 8, it may have excellent distortion and aberration characteristics in the periphery portion of the field of view (FOV).

$$0.1 < L 2 \_CT / L1\_CT < 0.8 \qquad [ Equation 9 ]$$

In Equation 9, L1_CT means a thickness (mm) on the optical axis OA of the first lens 110, and L2_CT means a thickness (mm) on the optical axis OA of the second lens 120. When the optical system 1000 according to the embodiment satisfies Equation 9, the optical system 1000 may control the aberration characteristic, thereby minimizing the occurrence of aberration.

$$0.1 < L7\_CT / L8\_CT < 0.8 \qquad [ Equation 10 ]$$

In Equation 10, L7_CT means a thickness (mm) on the optical axis OA of the seventh lens 170, and L8_CT means a thickness (mm) on the optical axis OA of the eighth lens 180. When the optical system 1000 according to the embodiment satisfies Equation 10, the optical system 1000 may obtain good optical performance in the periphery portion of the field of view (FOV).

$$0.2 < L8\_ET / L8\_CT < 0.8 \qquad [ Equation 11 ]$$

In Equation 11, L8_CT means a thickness (mm) on the optical axis OA of the eighth lens 180, and L8_ET means a thickness in a direction of the optical axis OA at the end of the effective region of the eighth lens 180. In detail, L8_ET means a distance in the direction of the optical axis OA between the end of the effective region of the object-side surface (fifteenth surface S15) of the eighth lens 180 and an end of the effective region of the sensor-side surface (sixteenth surface S16) of the eighth lens 180. When the optical system 1000 according to the embodiment satisfies Equation 11, the optical system 1000 may obtain good optical performance in the periphery portion of the field of view (FOV).

$$1.5 < L8\_CT / L9\_CT < 2 \qquad [ Equation 12 ]$$

In Equation 12, L8_CT means a thickness (mm) on the optical axis OA of the eighth lens 180, and L9_CT means a thickness (mm) on the optical axis OA of the ninth lens 190. When the optical system 1000 according to the embodiment satisfies Equation 12, the optical system 1000 may obtain good optical performance at the center of the field of view (FOV).

$$0.5 < Inf 71 / Inf 72 < 1.2 \qquad [ Equation 13 ]$$

In Equation 13, Inf71 means a linear distance (mm, based on the vertical direction of the optical axis OA) from the optical axis OA to the critical point (first critical point) disposed on the object-side surface (thirteenth surface S13) of the seventh lens 170. Also, Inf72 means a linear distance (mm, based on the vertical direction to the optical axis OA) from the optical axis OA to the critical point (second critical point) disposed on the sensor-side surface (fourteenth surface S14) of the seventh lens 170. When the optical system 1000 according to the embodiment satisfies Equation 13, the optical system 1000 may obtain good optical performance in the periphery portion of the field of view (FOV).

$$0.4 < Inf 71 / Inf 92 < 1 \qquad [ Equation 14 ]$$

In Equation 14, Inf71 means a linear distance (mm, based on the vertical direction to the optical axis OA) from the optical axis OA to the critical point to the critical point (first critical point) disposed on the object-side surface (thirteenth surface S13) of the seventh lens 170. Also, Inf92 means a linear distance (mm, based on the vertical direction to the optical axis OA) from the optical axis OA to the critical point (third critical point) disposed on the sensor-side surface (eighteenth surface S18) of the ninth lens 190. When the optical system 1000 according to the embodiment satisfies Equation 14, the optical system 1000 may obtain good optical performance in the periphery portion of the field of view (FOV).

$$0.4 < Inf 72 / Inf 92 < 1 \qquad [ Equation 15 ]$$

In Equation 15, Inf72 means a linear distance (mm, based on the vertical direction to the optical axis OA) from the optical axis OA to the critical point (second critical point) disposed on the sensor side (fourteenth surface S14) of the seventh lens 170. Also, Inf92 means a linear distance (mm, based on the vertical direction to the optical axis OA) from the optical axis OA to the critical point (third critical point) disposed on the sensor-side surface (eighteenth surface S18) of the ninth lens 190. When the optical system 1000 according to the embodiment satisfies Equation 15, the optical system 1000 may obtain good optical performance in the periphery portion of the field of view (FOV).

$$0.1 < T 11 / D 11 < 0.5 \qquad [ Equation 16 ]$$

In Equation 16, T11 means a distance in direction of the optical axis OA from a straight line orthogonal the vertex of the object-side surface (first surface S1) of the first lens 110 to the end of the effective diameter. In addition, D11 means a length in the vertical direction of the optical axis OA from the optical axis OA to the end of the effective region of the object-side surface (first surface S1) of the first lens 110. That is, D11 means an effective radius value (mm) of the object-side surface (first surface S1) of the first lens 110. When the optical system 1000 according to the embodiment satisfies Equation 16, the optical system 1000 may effectively control the incident light and control the aberration characteristics of the optical system 1000.

$$0 < T 91 / D 91 < 0.6 \qquad [ Equation 17 ]$$

In Equation 17, T91 means a distance in direction of the optical axis OA from a straight line orthogonal the vertex of the object-side surface (seventeenth surface S17) of the ninth lens 190 to an end of the effective diameter. In addition, D91 means a length in the vertical direction of the optical axis OA from the optical axis OA to the end of the effective region of the object-side surface (seventeenth surface S17) of the ninth lens 190. That is, D91 means an effective radius value (mm) of the object-side surface (seventeenth surface S17) of the ninth lens 190. When the optical system 1000 according to the embodiment satisfies Equation 17, the optical system 1000 may obtain good optical performance at the periphery portion of the field of view (FOV).

$$0 < T 92 / D 92 < 0.5 \qquad [ Equation 18 ]$$

In Equation 18, T92 means in direction of the optical axis OA from a straight line orthogonal the vertex of the sensor-side surface (eighteenth surface S18) of the ninth lens 190 to an end of the effective diameter. In addition, D92 means a length in the vertical direction of the optical axis OA from the optical axis OA to the end of the effective region of the sensor-side surface (eighteenth surface S18) of the ninth lens 190. That is, D92 means an effective radius value (mm) of the sensor-side surface (eighteenth surface S18) of the ninth lens 190. When the optical system 1000 according to the embodiment satisfies Equation 18, the optical system 1000 may obtain good optical performance at the periphery portion of the field of view (FOV).

$$1 < CA\_L 1 S 1 / CA\_L 3 S 1 < 2 \qquad [ Equation 19 ]$$

In Equation 19, CA_L1S1 means an effective diameter (or clear aperture (CA)) (mm) of an object-side surface (first surface S1) of the first lens 110, and CA_L3S1 means an effective diameter (or clear aperture (CA)) (mm) of the object-side surface (fifth surface (S5) of the third lens 130. When the optical system 1000 according to the embodiment satisfies Equation 19, the optical system 1000 may control the aberration characteristic, thereby minimizing the occurrence of aberration.

$$2 < CA\_L9S2 / CA\_L1S1 < 5 \qquad [ Equation 20 ]$$

In Equation 20, CA_L1S1 means an effective diameter (or clear aperture (CA)) (mm) of the object-side surface (first surface S1) of the first lens 110, and CA_L9S2 means an effective diameter (or clear aperture (CA)) (mm) of the sensor-side surface (eighteenth surface (S18)) of the ninth lens 190. When the optical system 1000 according to the embodiment satisfies Equation 19, the optical system 1000 may control the aberration characteristic, thereby minimizing the occurrence of aberration.

$$2 < L1\_CT / d12\_CT < 5 \qquad [ Equation 21 ]$$

In Equation 21, L1_CT means a thickness (mm) on the optical axis OA of the first lens 110, and d12_CT means a distance in a direction of the optical axis OA between the sensor-side surface (second surface S2) of the first lens 110 and the object-side surface (third surface S3) of the second lens 120. When the optical system 1000 according to the embodiment satisfies Equation 21, it is possible to effectively control the incident light, thereby controlling the aberration characteristic.

$$0.1 < L7\_CT / d 78 \_CT < 0.8 \qquad [ Equation 22 ]$$

In Equation 22, L7_CT means a thickness (mm) on the optical axis OA of the seventh lens 170, and d78_CT means a distance in a direction of the optical axis OA between the sensor-side surface (fourteenth surface S14) of the seventh lens 170 and the object-side surface (fifteenth surface S15) of the eighth lens 180. When the optical system 1000 according to the embodiment satisfies Equation 22, it is possible to control the aberration characteristics, so that the occurrence of aberration in the optical system 1000 may be minimized.

$$1.2 < L8\_CT / d78\_CT < 2.5 \qquad [ Equation 23 ]$$

In Equation 23, L8_CT means a thickness (mm) on the optical axis OA of the eighth lens 180, and d78_CT means a distance in a direction of the optical axis OA between the sensor-side surface (fourteenth surface S14) of the seventh lens 170 and the object-side surface (fifteenth surface S15) of the eighth lens 180. When the optical system 1000 according to the embodiment satisfies Equation 23, it is possible to control the aberration characteristics, so that the occurrence of aberration in the optical system 1000 may be minimized.

$$1 < d78\_CT / d78\_ET < 1.8 \qquad [ Equation 24 ]$$

In Equation 24, d78_CT means a distance in a direction of the optical axis OA between the sensor-side surface (fourteenth surface S14) of the seventh lens 170 and the object-side surface (fifteenth surface S15) of the eighth lens 180. In addition, d78_ET means a distance in a direction of the optical axis OA between the seventh lens 170 and the eighth lens 180 at the end of the effective region of the sensor-side surface (fourteenth surface S14) of the seventh lens 170. When the optical system 1000 according to the embodiment satisfies Equation 24, the resolution of the optical system 1000 may be improved and good optical characteristics may be obtained not only in the center portion of the field of view (FOV) but also in the periphery portion.

$$2 < L6\_CT / d67\_CT < 3 \qquad [ Equation 25 ]$$

In Equation 25, L6_CT means a thickness (mm) on the optical axis OA of the sixth lens 160, and d67_CT means a distance in a direction of the optical axis OA between the sensor-side surface (twelfth surface S12) of the sixth lens 160 and the object-side surface (thirteenth surface S13) of the seventh lens 170. When the optical system 1000 according to the embodiment satisfies Equation 25, the resolution of the optical system 1000 may be improved and good optical characteristics may be obtained not only in the center portion of the field of view (FOV) but also in the periphery portion.

$$1.5 < L7\_CT / d67\_CT < 4 \qquad [ Equation 26 ]$$

In Equation 26, L7_CT means the thickness (mm) on the optical axis OA of the seventh lens 170, and d67_CT means a distance in a direction of the optical axis OA between the sensor-side surface (twelfth surface S12) of the sixth lens 160 and the object-side surface (thirteenth surface S13) of the seventh lens 170. When the optical system 1000 according to the embodiment satisfies Equation 26, the resolution of the optical system 1000 may be improved and good optical characteristics may be obtained not only at the center portion of the field of view (FOV) but also at the periphery portion.

$$0.5 < d67\_CT / d67\_ET < 2.5 \qquad [ Equation 27 ]$$

In Equation 27, d67_CT means a distance in a direction of the optical axis OA between the sensor-side surface (twelfth surface S12) of the sixth lens 160 and the object-side surface (thirteenth surface S13) of the seventh lens 170. In addition, d67_ET means a distance in a direction of the optical axis OA between the sixth lens 160 and the seventh lens 170 at the end of the effective region of the sensor-side surface (twelfth surface S12) of the sixth lens 160. When the optical system 1000 according to the embodiment satisfies Equation 27, good optical performance may be obtained at the periphery portion of the field of view (FOV). In detail, when Equation 13 is satisfied, excellent distortion and aberration characteristics may be obtained at the periphery portion of the field of view (FOV).

$$0.5 < CA\_max / ( 2 * ImgH ) < 1 \qquad [ Equation 28 ]$$

In Equation 28, CA_max means the effective diameter (CA, mm) of the lens surface having the largest effective diameter (CA) among the object-side surfaces and the sensor-side surfaces of the plurality of lenses 100. ImgH means a vertical distance (mm) with respect to the optical axis OA from a region of a field 0, which is the center of the upper surface of the image sensor 300 overlapping the optical axis OA, to a region of a field 1.0 of the image sensor 300. When the optical system 1000 according to the embodiment satisfies Equation 28, the optical system 1000 may be provided in a slim and compact structure.

$$1.5 < CA\_max / CA\_Aver < 3 \qquad [ Equation 29 ]$$

In Equation 29, CA_max means the effective diameter (CA, mm) of the lens surface having the largest effective diameter (CA) among the object-side surfaces and the sensor-side surfaces of the plurality of lenses 100. In addition, CA_Aver means an average of the effective diameter (CA, mm) of the object-side surfaces and the sensor-side surfaces of the plurality of lenses 100. When the optical system 1000 according to the embodiment satisfies Equation 29, the optical system 1000 may be provided in a slim and compact structure, and may have an appropriate size for realizing optical performance.

$$0.5 < CA\_min / CA\_Aver < 1 \qquad [ Equation 30 ]$$

In Equation 30, CA_min means the effective diameter (CA, mm) of the lens surface having the smallest effective diameter (CA) among the object-side surfaces and the sensor-side surfaces of the plurality of lenses 100. In addition, CA_Aver means an average of the effective diameter (CA, mm) of the object-side surfaces and the sensor-side surfaces of the plurality of lenses 100. When the optical system 1000 according to the embodiment satisfies Equation 30, the optical system 1000 may be provided in a slim and compact structure, and may have an appropriate size for realizing optical performance.

$$2 < TTL < 20 \qquad [ Equation 31 ]$$

In Equation 31, TTL (Total Track Length) means a distance (mm) on the optical axis OA from the vertex of the object-side surface (first surface S1) of the first lens 110 to the upper surface of the image sensor 300.

$$2 < ImgH \qquad [ Equation 32 ]$$

In Equation 32, ImgH means a vertical distance (mm) with respect to the optical axis OA from a region of a field 0, which is the center of the upper surface of the image sensor 300 overlapping the optical axis OA, to a region of a field 1.0 of the image sensor 300. That is, ImgH means ½ of the maximum diagonal length (mm) of the effective region of the image sensor 300.

$$BFL < 2.5 \qquad [ Equation 33 ]$$

In Equation 33, BFL (Back focal length) means a distance (mm) on the optical axis OA from the vertex of the sensor-side surface of the lens closest to the image sensor 300 to the upper surface of the image sensor 300.

$$1 < TTL / ImgH < 2 \qquad [ Equation 34 ]$$

In Equation 34, a relationship between total track length (TTL) and ImgH may be set. When the optical system 1000 according to the embodiment satisfies Equation 34, the optical system 1000 may secure the BFL for applying the image sensor 300 having a relatively large size, for example, the image sensor 300 having a size of about 1 inch, and may have a smaller TTL, and thus may have a high-definition image quality and a slim structure.

$$0.1 < BFL / ImgH < 0.5 \qquad [ Equation 35 ]$$

In Equation 35, a relationship between a back focal length (BFL) and ImgH may be established. When the optical system according to the embodiment satisfies Equation 35, the optical system 1000 may secure the BFL for applying the image sensor 300 having a relatively large size, for example, the image sensor 300 having a size of about 1 inch, and may minimize the distance between the last lens and the image sensor 300, so that good optical properties may be obtained in the center portion and periphery portion of the field of view (FOV).

$$6 < TTL / BFL < 8 \qquad [ Equation 36 ]$$

In Equation 36, a total track length (TTL) and a back focal length (BFL) may be set. When the optical system 1000 according to the embodiment satisfies Equation 36, the optical system 1000 may be provided in a slim and compact structure.

$$0.1 < F / TTL < 1 \qquad [ Equation 37 ]$$

In Equation 37, F means the total focal length (mm) of the optical system 1000. In Equation 37, the relationship between the total focal length and total track length (TTL) may be set. When the optical system 1000 according to the embodiment satisfies Equation 37, the optical system 1000 may be provided in a slim and compact structure.

$$3 < F / BFL < 8 \qquad [ Equation 38 ]$$

In Equation 38, a relationship between F and a back focal length (BFL) can be established. When the optical system 1000 according to the embodiment satisfies Equation 38, the optical system 1000 may minimize the distance between the last lens and the image sensor 300, and thus may have good optical characteristics at the periphery portion of the field of view (FOV).

$$1 < F / ImgH < 3 \qquad [ Equation 39 ]$$

In Equation 39, a relationship between F and ImgH may be established. When the optical system 1000 according to the embodiment satisfies Equation 39, the optical system 1000 applies a large-sized image sensor 300, for example, an image sensor 300 of about 1 inch in size, and achieves high resolution and high image quality. It may be implemented, and may have improved aberration characteristics.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + ⋯ \qquad [ Equation 40 ]$$

In Equation 40, Z is Sag, which may mean a distance in the optical axis direction from an arbitrary position on the aspherical surface to the vertex of the aspherical surface. Y may mean a distance in a direction perpendicular to the optical axis from any position on the aspherical surface to the optical axis. c may mean a curvature of a lens, and K may mean a conic constant. A, B, C, D, E, and F may mean an aspheric constant.

The optical system 1000 according to the embodiment may satisfy at least one or two or more of Equations 1 to 39. In this case, the optical system 1000 may have improved optical properties. In detail, when the optical system 1000 satisfies at least one or two or more of Equations 1 to 39, the optical system 1000 has improved resolution and may improve aberration and peripheral distortion characteristics.

When the optical system 1000 satisfies at least one or two or more of Equations 1 to 39, it may include the image sensor 300 having a relatively large size and may have a relatively small TTL value, and the optical system 1000 and a camera module including the same may have a slimmer and more compact structure.

The distance between the plurality of lenses 100 in the optical system 1000 according to the embodiment may have a value set according to a region.

The sixth lens 160 and the seventh lens 170 may be spaced apart from each other by a first distance. The first distance may be an interval in a direction of the optical axis OA between the sixth lens 160 and the seventh lens 170. The first distance may vary according to a position between the sixth lens 160 and the seventh lens 170. In detail, when the optical axis OA is the starting point and an end of the effective region of the sensor-side surface (twelfth surface S12) of the sixth lens 160 is the endpoint, the first distance may vary from the optical axis OA toward a direction perpendicular to the optical axis OA. That is, the first distance may change from the optical axis OA toward the end of the effective diameter of the twelfth surface S12. The first distance may increase from the optical axis OA toward the first point EG1 located on the twelfth surface S12. When the optical axis OA is the starting point and the end point of the effective region of the twelfth surface S12 is the end point, the first point EG1 may be disposed in a range of about 65% to 85% of the effective radius of the twelfth surface S12 with respect to the optical axis. The first distance may decrease from the first point EG1 in a direction perpendicular to the optical axis OA. For example, the first distance may decrease from the first point EG1 to a second point EG2 located on the twelfth surface S12. Here, the second point EG2 may be the end of the effective region of the twelfth surface S12. The first distance may have a maximum value at the first point EG1. Also, the first distance may have a minimum value at the optical axis OA or the second point EG2. In this case, the maximum value of the first distance may be about 1.5 times or more of the minimum value. In detail, the maximum value of the first distance may satisfy about 1.5 times to about 5 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the sixth lens 160 and the seventh lens 170 are spaced apart at distances set according to positions, and may have good optical properties not only at the center portion but also at the periphery portion.

The seventh lens 170 and the eighth lens 180 may be spaced apart from each other by a second distance. The second distance may be a distance in the optical axis OA direction between the seventh lens 170 and the eighth lens 180. The second distance may vary according to a position between the seventh lens 170 and the eighth lens 180. In detail, when the optical axis OA is the starting point and the end point of the effective region of the sensor side (fourteenth surface S14) of the seventh lens 170 is the endpoint, the second distance may vary from the optical axis OA toward a direction perpendicular to the optical axis OA. That is, the first distance may change from the optical axis OA toward the end of the effective diameter of the fourteenth surface S14. The second distance may decrease from the optical axis OA toward the third point EG3 positioned on the fourteenth surface S14. Here, the third point EG3 may be the end of the effective region of the fourteenth surface S14. The second distance may have a maximum value in the optical axis OA. Also, the second distance may have a minimum value at the third point EG3 located on the fourteenth surface S14. In this case, the maximum value of the second distance may be about 1.2 times or more of the minimum value. In detail, the maximum value of the second distance may satisfy about 1.2 times to about 2 times the minimum value. Accordingly, the optical system 1000 may have improved optical properties not only in the central portion of the field of view (FOV) but also in the peripheral portion. In addition, the optical system 1000 may have improved distortion control characteristics as the seventh lens 170 and the eighth lens 180 are spaced apart at distances set according to positions.

The eighth lens 180 and the ninth lens 190 may be spaced apart from each other by a third distance. The third distance may be a distance in the optical axis OA direction between the eighth lens 180 and the ninth lens 190. The third distance may vary depending on a position between the eighth lens 180 and the ninth lens. In detail, when the optical axis OA is the starting point and the end of the sensor-side surface (the sixteenth surface S16) of the eighth lens 180 is the endpoint, the third distance may vary from the optical axis OA toward a direction perpendicular to the optical axis OA. That is, the third distance may change from the optical axis OA toward the end of the effective diameter of the sixteenth surface S16. The third distance may increase from the optical axis OA toward the fourth point EG4 positioned on the sixteenth surface S16. When the optical axis OA is the starting point and the end of the sixteenth surface S16 is the endpoint, the fourth point EG4 may be disposed in a range of about 20% to about 35% based on the direction perpendicular to the optical axis OA. The third distance may decrease from the fourth point EG4 in a direction perpendicular to the optical axis OA. For example, the third distance may decrease from the fourth point EG4 to a fifth point EG5 located on the sixteenth surface S16. When the optical axis OA is the starting point and the end of the sixteenth surface S16 is the end point, the fifth point EG5 may be disposed in a range of about 70% to about 80% based on the direction perpendicular to the optical axis OA.

The third distance may increase from the fifth point EG5 in a direction perpendicular to the optical axis OA. For example, the third distance may increase from the fifth point EG5 toward a sixth point EG6 located on the sixteenth surface S16. Here, the sixth point EG6 may be an end of the effective region of the sixteenth surface S16. The third distance may have a maximum value at the fourth point EG4. Also, the third distance may have a minimum value at the fifth point EG5. In this case, the maximum value of the third distance may satisfy about 4 to about 6 times the minimum value. Accordingly, the optical system 1000 may have improved optical characteristics in the periphery portion of the field of view (FOV). In detail, the optical system 1000 according to the embodiment may have improved distortion control characteristics as the eighth lens 180 and the ninth lens 190 are spaced apart at distances set according to positions.

Hereinafter, the optical system 1000 according to each embodiment will be described in more detail with reference to the drawings.

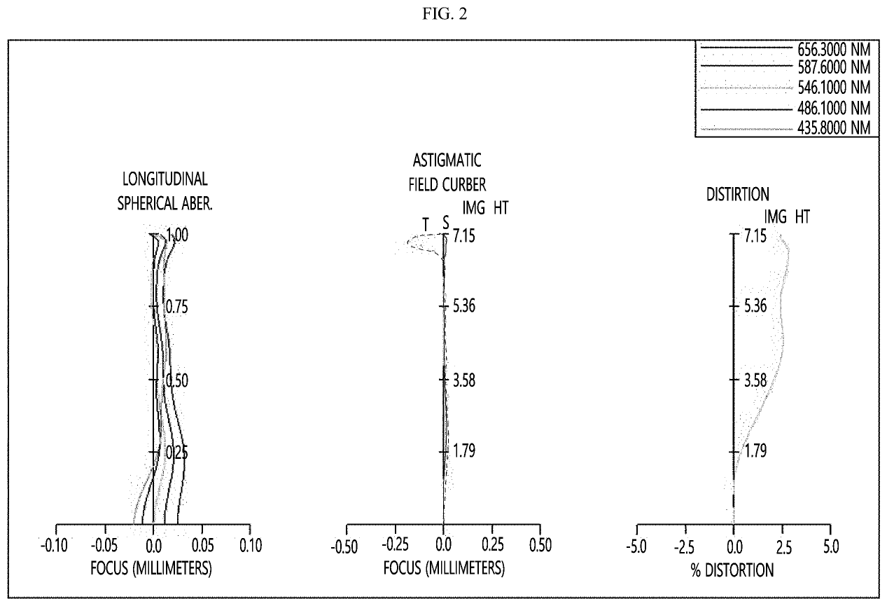

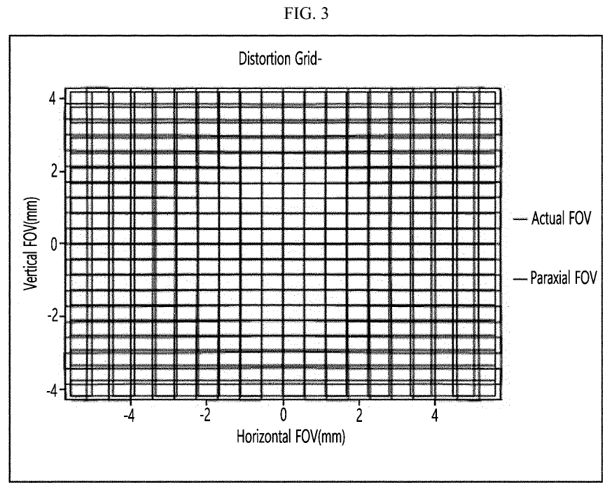

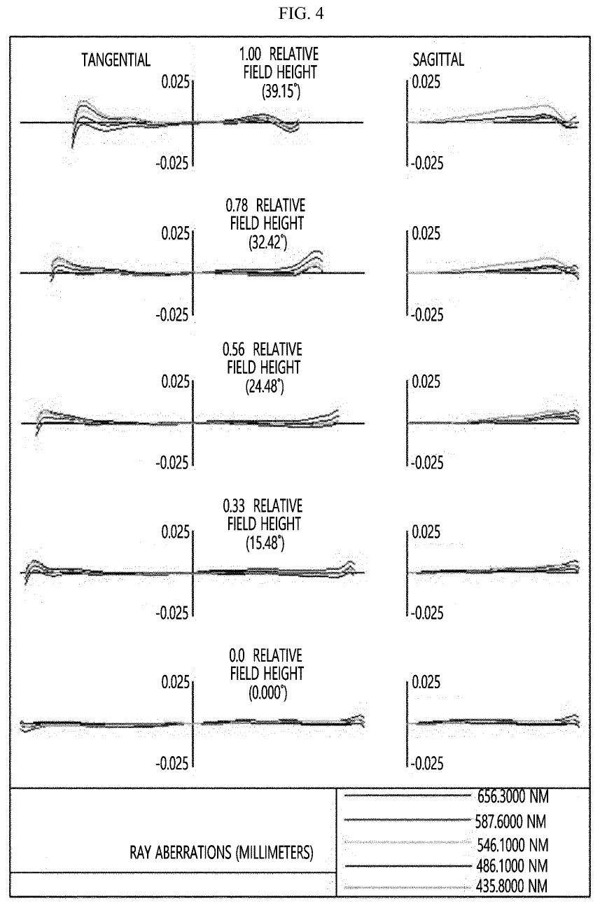

FIG. 1 is a configuration diagram of an optical system according to a first embodiment, and FIG. 2 is a graph showing an aberration diagram of the optical system according to the first embodiment. Also, FIG. 3 is a view showing a distortion grid of the optical system according to the first embodiment, and FIG. 4 is a view showing coma aberration of the optical system according to the first embodiment.

Referring to FIGS. 1 to 4, the optical system 1000 according to the first embodiment may include the first lens 110 to the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the first embodiment, an aperture stop may be disposed between the first lens 110 and the second lens 120.

A filter 500 may be disposed between the plurality of lenses 100 and the image sensor 300. In detail, the filter 500 may be disposed between the ninth lens 190 and the image sensor 300.

TABLE 1

| | | Radius of | Thickness (mm)/ | Reflective | Abbe | Effective |
|---|---|---|---|---|---|---|
| Lens | Surface | curvature | Distance (mm) | Index | number | diameter (mm) |
| Lens 1 | S1 | 3.101 | 1.112 | 1.544 | 56.115 | 4.124 |
| | S2 | 15.937 | 0.287 | | | 3.818 |
| Stop | | Infinity | −0.24 | | | |
| Lens 2 | S3 | 5.636 | 0.436 | 1.671 | 19.38 | 3.532 |
| | S4 | 3.606 | 0.505 | | | 3.182 |
| Lens 3 | S5 | −27.158 | 0.323 | 1.544 | 56.115 | 3.182 |
| | S6 | −16.464 | 0.081 | | | 3.200 |
| Lens 4 | S7 | 34.452 | 0.559 | 1.588 | 28.269 | 3.408 |
| | S8 | 15.092 | 0.09 | | | 4.010 |
| Lens 5 | S9 | 194.836 | 0.433 | 1.544 | 56.115 | 4.364 |
| | S10 | −25.856 | 0.073 | | | 4.604 |
| Lens 6 | S11 | −48.711 | 0.4 | 1.544 | 56.115 | 4.770 |
| | S12 | −31.031 | 0.139 | | | 5.158 |
| Lens 7 | S13 | 4.595 | 0.444 | 1.588 | 28.269 | 5.278 |
| | S14 | 4.384 | 0.787 | | | 6.444 |
| Lens 8 | S15 | 27.338 | 1.502 | 1.544 | 56.115 | 7.342 |
| | S16 | −2.973 | 0.421 | | | 8.514 |
| Lens 9 | S17 | −5.019 | 0.793 | 1.534 | 55.656 | 10.010 |
| | S18 | 2.993 | 0.511 | | | 11.584 |
| Filter | | Infinity | 0.21 | 1.517 | 64.167 | |
| | | Infinity | 0.635 | | | |
| Image | | Infinity | | | | |
| sensor | | | | | | |

Table 1 shows, in the first to ninth lenses 110, 120, 130, 140, 150, 160, 170, 180, and 190 according to the first embodiment the radius of curvature on the optical axis OA, the center thickness of each lens, the distance between adjacent lenses, refractive index at the d-line, Abbe number, and a size of the effective diameter (clear aperture (CA)). The first lens 110 of the optical system 1000 according to the first embodiment may have a positive (+) refractive power on the optical axis OA. The first surface S1 of the first lens 110 may have a convex shape on the optical axis OA, and the second surface S2 may have a concave shape on the optical axis OA. The first lens 110 may have a meniscus shape convex from the optical axis OA toward the object side. The first surface S1 and the second surface S2 may have aspheric coefficients as shown in Table 2 below. The second lens 120 may have negative (−) refractive power on the optical axis OA. The third surface S3 of the second lens 120 may have a convex shape on the optical axis OA, and the fourth surface S4 may have a concave shape on the optical axis OA. The second lens 120 may have a meniscus shape convex from the optical axis OA toward the object side. The third surface S3 may be an aspherical surface, and the fourth surface S4 may be an aspherical surface. The third surface S3 and the fourth surface S4 may have aspheric coefficients as shown in Table 2 below.

The third lens 130 may have positive (+) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor side. The fifth surface S5 may be an aspherical surface, and the sixth surface S6 may be an aspherical surface. The fifth surface S5 and the sixth surface S6 may have aspheric coefficients as shown in Table 2 below. The fourth lens 140 may have negative (−) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape convex from the optical axis OA toward the object side. The seventh surface S7 may be an aspherical surface, and the eighth surface S8 may be an aspherical surface. The seventh surface S7 and the eighth surface S8 may have aspheric coefficients as shown in Table 2 below.

The fifth lens 150 may have a positive (+) refractive power on the optical axis OA. The ninth surface S9 of the fifth lens 150 may have a convex shape on the optical axis OA, and the tenth surface S10 may have a convex shape on the optical axis OA. The fifth lens 150 may have a shape in which both sides are convex on the optical axis OA. The ninth surface S9 may be an aspherical surface, and the tenth surface S10 may be an aspherical surface. The ninth surface S9 and the tenth surface S10 may have aspheric coefficients as shown in Table 2 below. The sixth lens 160 may have a positive (+) refractive power on the optical axis OA. The eleventh surface S11 of the sixth lens 160 may have a concave shape on the optical axis OA, and the twelfth surface S12 may have a convex shape on the optical axis OA. The sixth lens 160 may have a meniscus shape convex from the optical axis OA toward the sensor. The eleventh surface S11 may be an aspherical surface, and the twelfth surface S12 may be an aspherical surface. The eleventh surface S11 and the twelfth surface S12 may have aspheric coefficients as shown in Table 2 below.

The seventh lens 170 may have negative (−) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspheric coefficients as shown in Table 2 below. The seventh lens 170 may include a critical point. In detail, the above-described first critical point may be disposed on the thirteenth surface S13 of the seventh lens 170. In addition, the above-described second critical point may be disposed on the fourteenth surface S14 of the seventh lens 170.

The eighth lens 180 may have positive (+) refractive power on the optical axis OA. The fifteenth surface S15 of the eighth lens 180 may have a convex shape on the optical axis OA, and the sixteenth surface S16 may have a convex shape on the optical axis OA. The eighth lens 180 may have a shape in which both sides are convex on the optical axis OA. The fifteenth surface S15 may be an aspherical surface, and the sixteenth surface S16 may be an aspherical surface. The fifteenth surface S15 and the sixteenth surface S16 may have aspheric coefficients as shown in Table 2 below. The ninth lens 190 may have negative (−) refractive power on the optical axis OA. The seventeenth surface S17 of the ninth lens 190 may have a concave shape on the optical axis OA, and the eighteenth surface S18 may have a concave shape on the optical axis OA. The ninth lens 190 may have a concave shape on both sides of the optical axis OA. The seventeenth surface S17 may be an aspherical surface, and the eighteenth surface S18 may be an aspherical surface. The seventeenth surface S17 and the eighteenth surface S18 may have aspheric coefficients as shown in Table 2 below. The ninth lens 190 may include a critical point. In detail, the third critical point may be disposed on the eighteenth surface S18 of the ninth lens 190.

The values of the aspheric coefficients of each lens surface in the optical system 1000 according to the first embodiment are shown in Table 2 below.

TABLE 2

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 1.17E−02 | 1.14E−01 | −2.78E−01 | 9.17E−01 | 0 | 0 | 0 | 0 | 0 |
| A | −3.66E−04 | −2.17E−02 | −2.41E−02 | −8.79E−03 | −1.23E−03 | 1.14E−03 | −1.42E−02 | −2.23E−02 | −3.87E−03 |
| B | 1.93E−03 | 2.93E−02 | 2.59E−02 | 7.37E−03 | 4.50E−03 | 1.22E−02 | 2.03E−02 | 2.37E−02 | 2.14E−02 |
| D | −2.85E−03 | −2.67E−02 | −1.87E−02 | −9.91E−03 | −1.93E−02 | −4.05E−02 | −4.54E−02 | −3.13E−02 | −2.97E−02 |
| E | 2.42E−03 | 1.69E−02 | 8.22E−03 | 1.60E−02 | 3.32E−02 | 5.70E−02 | 5.36E−02 | 2.24E−02 | 2.05E−02 |
| F | −1.30E−03 | −7.42E−03 | −1.13E−03 | −1.75E−02 | −3.37E−02 | −4.77E−02 | −3.89E−02 | −9.71E−03 | −8.28E−03 |
| G | 4.42E−04 | 2.19E−03 | −7.23E−04 | 1.21E−02 | 2.13E−02 | 2.51E−02 | 1.79E−02 | 2.63E−03 | 2.06E−03 |
| H | −9.19E−05 | −4.13E−04 | 4.11E−04 | −5.00E−03 | −8.14E−03 | −8.14E−03 | −5.04E−03 | −4.41E−04 | −3.14E−04 |
| I | 1.07E−05 | 4.51E−05 | −8.40E−05 | 1.13E−03 | 1.72E−03 | 1.48E−03 | 7.96E−04 | 4.16E−05 | 2.68E−05 |
| J | −5.31E−07 | −2.16E−06 | 6.39E−06 | −1.06E−04 | −1.55E−04 | −1.15E−04 | −5.39E−05 | −1.69E−06 | −9.91E−07 |
| | L5 | L6 | | L7 | | L8 | | L9 | |
| | S10 | S11 | S12 | S13 | S14 | S15 | S16 | S17 | S18 |
| K | 0 | 0 | 0 | −7.46E−01 | −1.88E+00 | −6.58E+01 | −1.11E+00 | −1.74E+00 | −9.39E+00 |
| A | −2.17E−03 | −1.54E−04 | −8.94E−05 | −2.79E−02 | −2.36E−02 | 1.62E−03 | 3.52E−02 | 9.24E−04 | −1.13E−02 |
| B | 4.16E−03 | −1.12E−03 | 2.04E−03 | 7.55E−03 | 4.25E−03 | −1.29E−03 | −1.08E−02 | −5.03E−03 | 1.55E−03 |
| D | −3.33E−03 | 1.47E−03 | −1.70E−03 | −2.36E−03 | −4.87E−04 | −6.54E−05 | 2.09E−03 | 1.20E−03 | −1.64E−04 |
| E | 1.33E−03 | −1.06E−03 | 6.55E−04 | 3.76E−04 | −1.15E−04 | 1.38E−04 | −2.39E−04 | −1.32E−04 | 1.21E−05 |
| F | −2.26E−04 | 4.42E−04 | −1.52E−04 | 4.28E−06 | 5.57E−05 | −4.22E−05 | 1.58E−05 | 8.46E−06 | −5.73E−07 |
| G | −1.39E−05 | −1.12E−04 | 2.51E−05 | −1.57E−05 | −9.54E−06 | 6.34E−06 | −5.10E−07 | −3.38E−07 | 1.54E−08 |
| H | 1.18E−05 | 1.68E−05 | −3.15E−06 | 3.34E−06 | 8.47E−07 | −5.19E−07 | 6.66E−10 | 8.32E−09 | −1.64E−10 |
| I | −1.69E−06 | −1.39E−06 | 2.58E−07 | −3.31E−07 | −3.85E−08 | 2.21E−08 | 4.31E−10 | −1.16E−10 | −1.06E−12 |
| J | 8.17E−08 | 4.86E−08 | −9.52E−09 | 1.32E−08 | 7.03E−10 | −3.85E−10 | −8.58E−12 | 6.98E−13 | 2.70E−14 |

In addition, in the optical system 1000 according to the first embodiment, the first distance d67 between the sensor-side surface of the sixth lens 160 and the object-side surface of the seventh lens 170 from the optical axis toward a direction perpendicular to the optical axis may be as shown in Table 3 below.

TABLE 3

| Vertical height (mm) to | | Vertical height (mm) to |
|---|---|---|
| the optical axis from | | the optical axis from |
| the optical axis at the | First | the optical axis at the |
| sensor-side surface of | distance | object-side surface of |
| the sixth lens | (d67) (mm) | the seventh lens |
| 0.000 | 0.139 | 0.000 |
| 0.100 | 0.141 | 0.100 |
| 0.200 | 0.144 | 0.200 |
| 0.300 | 0.150 | 0.300 |
| 0.400 | 0.159 | 0.400 |
| 0.500 | 0.169 | 0.500 |
| 0.600 | 0.181 | 0.600 |
| 0.700 | 0.194 | 0.700 |
| 0.800 | 0.209 | 0.800 |
| 0.900 | 0.225 | 0.900 |
| 1.000 | 0.241 | 1.000 |
| 1.100 | 0.258 | 1.100 |
| 1.200 | 0.275 | 1.200 |
| 1.300 | 0.292 | 1.300 |
| 1.400 | 0.308 | 1.400 |
| 1.500 | 0.323 | 1.500 |
| 1.600 | 0.336 | 1.600 |
| 1.700 | 0.348 | 1.700 |
| 1.800 | 0.357 | 1.800 |
| 1.900 (EG1) | 0.362 | 1.900 (EG1) |
| 2.000 | 0.362 | 2.000 |
| 2.100 | 0.357 | 2.100 |
| 2.200 | 0.344 | 2.200 |
| 2.300 | 0.320 | 2.300 |
| 2.400 | 0.280 | 2.400 |
| 2.500 | 0.218 | 2.500 |
| 2.579 (EG2) | 0.122 | 2.579 (EG2) |

Referring to Table 3, the first distance may increase from the optical axis OA toward the first point EG1 located on the twelfth surface S12. When the optical axis OA is the starting point and the end point of the effective region of the twelfth surface S12 is the end point, the first point EG1 may be disposed in the range of about 65% to about 85% of the effective radius of the twelfth surface S12 with respect to the optical axis OA. Here, the distance between the start point, which is the optical axis of each lens surface, and the end or edge of the effective region represents the effective radius. In the first embodiment, the second point EG2 may be disposed at a position that is about 73.67% of the effective radius of the twelfth surface S12 with respect to the optical axis OA. The first distance may decrease from the first point EG1 to the second point EG2 that is the outer end of the effective region of the twelfth surface S12. Here, the value of the second point EG2 is an effective radius value of the twelfth surface S12 having a smaller effective diameter of the sensor-side surface (twelfth surface S12) of the sixth lens 160 and the object-side surface S13 of the seventh lens 170 facing each other, and means ½ of the effective diameter value of the twelfth surface S12 shown in Table 1. The first distance may have a maximum value at the first point EG1 and a minimum value at the second point EG2. The maximum value of the second distance may be about 1.5 times to about 5 times the minimum value. For example, in the first embodiment, the maximum value of the first distance may be about 2.96 times the minimum value. The second distance d78 between the sensor-side surface of the seventh lens 170 and the object-side surface of the eighth lens 180 in a direction perpendicular to the optical axis in the optical system 1000 according to the first embodiment may be as shown in Table 4 below.

TABLE 4

| Vertical height (mm) to | | Vertical height (mm) to |
|---|---|---|
| the optical axis from | | the optical axis from |
| the optical axis at the | Second | the optical axis at the |
| sensor-side surface of | distance | object-side surface of |
| the seventh lens | (d78) (mm) | the eighth lens |
| 0.000 | 0.787 | 0.000 |
| 0.100 | 0.786 | 0.100 |
| 0.200 | 0.783 | 0.200 |
| 0.300 | 0.779 | 0.300 |
| 0.400 | 0.772 | 0.400 |
| 0.500 | 0.765 | 0.500 |
| 0.600 | 0.756 | 0.600 |
| 0.700 | 0.746 | 0.700 |
| 0.800 | 0.735 | 0.800 |
| 0.900 | 0.724 | 0.900 |
| 1.000 | 0.712 | 1.000 |
| 1.100 | 0.701 | 1.100 |
| 1.200 | 0.689 | 1.200 |
| 1.300 | 0.678 | 1.300 |
| 1.400 | 0.667 | 1.400 |
| 1.500 | 0.657 | 1.500 |
| 1.600 | 0.648 | 1.600 |
| 1.700 | 0.639 | 1.700 |
| 1.800 | 0.631 | 1.800 |
| 1.900 | 0.625 | 1.900 |
| 2.000 | 0.619 | 2.000 |
| 2.100 | 0.614 | 2.100 |
| 2.200 | 0.610 | 2.200 |
| 2.300 | 0.607 | 2.300 |
| 2.400 | 0.603 | 2.400 |
| 2.500 | 0.600 | 2.500 |
| 2.600 | 0.597 | 2.600 |
| 2.700 | 0.593 | 2.700 |
| 2.800 | 0.588 | 2.800 |
| 2.900 | 0.583 | 2.900 |
| 3.000 | 0.576 | 3.000 |
| 3.100 | 0.568 | 3.100 |
| 3.200 | 0.561 | 3.200 |
| 3.222 (EG3) | 0.559 | 3.222 (EG3) |

Referring to Table 4, the second distance may decrease from the optical axis OA toward the third point EG3 located on the fourteenth surface S14. The third point EG3 may be an outer end of the effective region of the fourteenth surface S14. Here, the value of the third point EG3 is an effective radius value of the fourteenth surface S14 having a smaller effective diameter of the fourteenth surface S14 of the seventh lens 170 and the object-side surface S15 of the eighth lens 180 facing each other, means ½ of the effective radius value of the fourteenth surface S14 shown in Table 1. The second distance may have a maximum value at the optical axis OA and a minimum value at the third point EG3. The maximum value of the second distance may be about 1.2 times to about 2 times the minimum value. For example, in the first embodiment, the maximum value of the second distance may be about 1.4 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions. The third distance d89 between the sensor-side surface of the eighth lens 180 and the object-side surface of the ninth lens 190 along the direction perpendicular to the optical axis in the optical system 1000 according to the first embodiment may be shown in the table 5 below.

TABLE 5

| Vertical height (mm) to | | Vertical height (mm) to |
|---|---|---|
| the optical axis from | | the optical axis from |
| the optical axis at the | Third | the optical axis at the |
| sensor-side surface of | distance | object-side surface of |
| the eighth lens | (d89) (mm) | the ninth lens |
| 0.000 | 0.421 | 0.000 |
| 0.100 | 0.422 | 0.100 |
| 0.200 | 0.424 | 0.200 |
| 0.300 | 0.427 | 0.300 |
| 0.400 | 0.432 | 0.400 |
| 0.500 | 0.437 | 0.500 |
| 0.600 | 0.442 | 0.600 |
| 0.700 | 0.447 | 0.700 |
| 0.800 | 0.453 | 0.800 |
| 0.900 | 0.457 | 0.900 |
| 1.000 | 0.461 | 1.000 |
| 1.100 | 0.463 | 1.100 |
| 1.200 (EG4) | 0.464 | 1.200 (EG4) |
| 1.300 | 0.462 | 1.300 |
| 1.400 | 0.458 | 1.400 |
| 1.500 | 0.452 | 1.500 |
| 1.600 | 0.442 | 1.600 |
| 1.700 | 0.430 | 1.700 |
| 1.800 | 0.415 | 1.800 |
| 1.900 | 0.397 | 1.900 |
| 2.000 | 0.376 | 2.000 |
| 2.100 | 0.352 | 2.100 |
| 2.200 | 0.326 | 2.200 |
| 2.300 | 0.298 | 2.300 |
| 2.400 | 0.269 | 2.400 |
| 2.500 | 0.239 | 2.500 |
| 2.600 | 0.209 | 2.600 |
| 2.700 | 0.180 | 2.700 |
| 2.800 | 0.153 | 2.800 |
| 2.900 | 0.129 | 2.900 |
| 3.000 | 0.109 | 3.000 |
| 3.100 | 0.093 | 3.100 |
| 3.200 | 0.083 | 3.200 |
| 3.300 (EG5) | 0.079 | 3.300 (EG5) |
| 3.400 | 0.082 | 3.400 |
| 3.500 | 0.093 | 3.500 |
| 3.600 | 0.113 | 3.600 |
| 3.700 | 0.141 | 3.700 |
| 3.800 | 0.177 | 3.800 |
| 3.900 | 0.221 | 3.900 |
| 4.000 | 0.271 | 4.000 |
| 4.100 | 0.321 | 4.100 |
| 4.200 | 0.366 | 4.200 |
| 4.257 (EG6) | 0.400 | 4.257 (EG6) |

Referring to Table 5, the third distance may increase from the optical axis OA toward the fourth point EG4 located on the sixteenth surface S16. When the optical axis OA is the starting point and the end point of the effective region of the sixteenth surface S16 is the end point, the fourth point EG4 may be disposed in the range of about 20% to about 35% of the effective radius of the sixteenth surface S16 with respect to the optical axis OA. For example, in the first embodiment, the fourth point EG4 may be arranged in a range of about 28.2%. Also, the third distance may decrease from the fourth point EG4 toward a fifth point EG5 located on the sixteenth surface S16. When the optical axis OA is the starting point and the effective region end of the sixteenth surface S19 is the end point, the fifth point EG5 may be disposed in the range of about 70% to about 80% in the direction perpendicular to the optical axis OA. For example, in the first embodiment, the fifth point EG5 may be arranged in a range of about 77.5%. Also, the third distance may increase from the fifth point EG5 toward the sixth point EG6 that is the end of the effective diameter of the sixteenth surface S16. Here, the value of the sixth point EG6 is an effective radius value of the sixteenth surface S16 having a smaller effective diameter of the sensor-side surface (sixteenth surface S16) of the eighth lens 180 and the object-side surface (seventeenth surface S17) of the ninth lens 190 facing each other, and means ½ of the effective diameter value of the sixteenth surface S16 described in Table 1. The third distance may have a maximum value at the fourth point EG4 and a minimum value at the fifth point EG5. The maximum value of the third distance may be about 4 times to about 6 times the minimum value. For example, in the first embodiment, the maximum value of the third distance may be about 5.85 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions.

FIG. 2 is a graph of an aberration diagram of the optical system 1000 according to the first embodiment, in which spherical aberration (Longitudinal spherical aberration), astigmatic field curves, and distortion are measured from left to right. In FIG. 2, the X-axis may indicate a focal length (mm) or distortion (%), and the Y-axis may indicate the height of an image. In addition, the graph for spherical aberration is a graph for light in a wavelength band of about 435 nm, about 486 nm, about 546 nm, about 587 nm, and about 656 nm, and the graph for astigmatism and distortion aberration is a graph for light in the wavelength band of 546 nm.

FIG. 3 is a view showing a distortion grid of the optical system 1000 according to the first embodiment, and the optical system 1000 may have the same distortion characteristics as in FIG. 3. FIG. 4 is a graph showing coma aberration of the optical system 1000 according to the first embodiment, and is a graph of measuring the aberration of the tangential component and the sagittal component of the light in wavelength bands of about 435 nm, about 486 nm, about 546 nm, about 587 nm, and about 656 nm depending on the field height of the image. The interpretation of the coma graph may be interpreted that the closer the X-axis on the positive and negative axes, the better the coma correction function. Referring to FIGS. 2 to 4, the optical system 1000 according to the first embodiment has improved resolution as the plurality of lenses 100 have a set shape, focal length, set distance, and the like, and the angle of view (FOV) and may provide good optical performance not only at the center portion but also at the periphery portion.

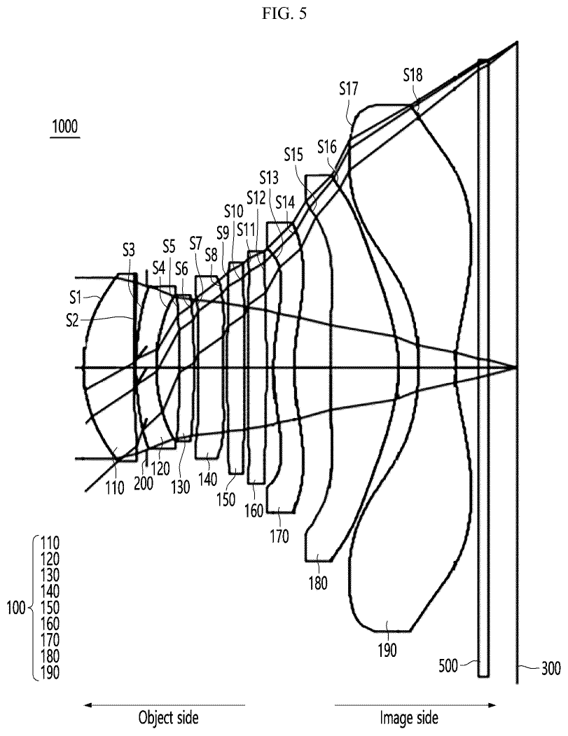

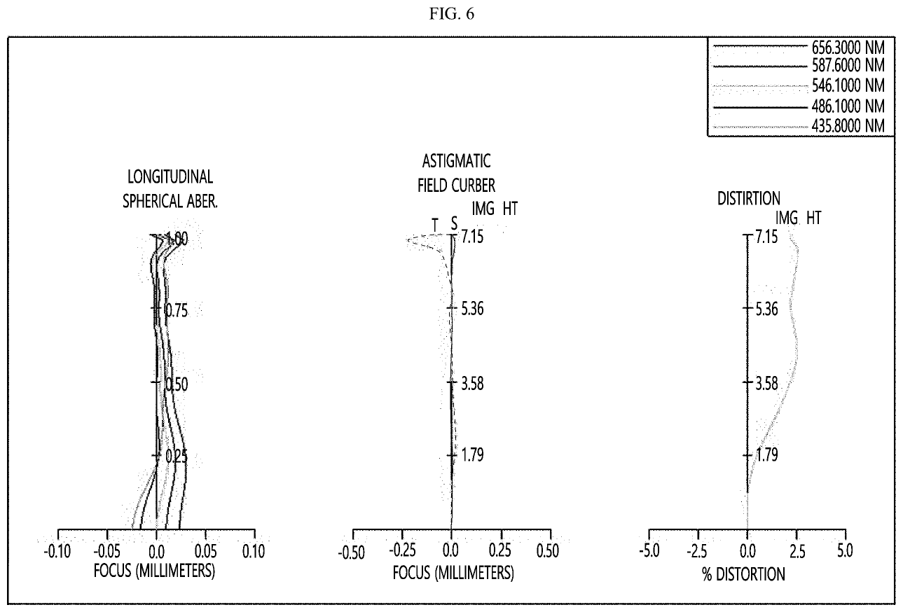

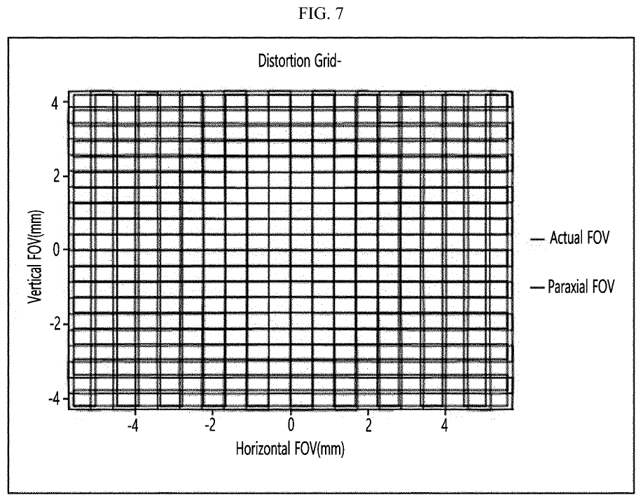

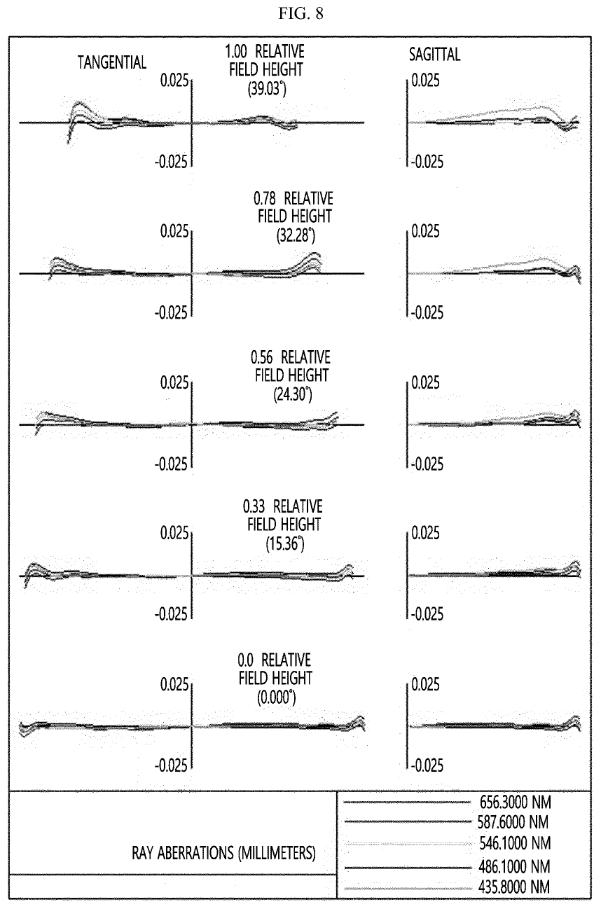

FIG. 5 is a configuration diagram of an optical system according to the second embodiment, and FIG. 6 is a graph showing an aberration diagram of the optical system according to the second embodiment. In addition, FIG. 7 is a view showing a distortion grid of the optical system according to the second embodiment, and FIG. 8 is a view showing coma aberration of the optical system according to the second embodiment.

Referring to FIGS. 5 to 8, the optical system 1000 according to the second embodiment may include the first lens 110 to the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the second embodiment, an aperture stop may be disposed between the first lens 110 and the second lens 120. Also, a filter 500 may be disposed between the plurality of lenses 100 and the image sensor 300. In detail, the filter 500 may be disposed between the ninth lens 190 and the image sensor 300.

TABLE 6

| | | Radius of | Thickness (mm)/ | Reflective | Abbe | Effective |
|---|---|---|---|---|---|---|
| Lens | Surface | curvature | Distance (mm) | Index | number | diameter (mm) |
| Lens 1 | S1 | 3.075 | 1.102 | 1.534 | 55.656 | 4.124 |
| | S2 | 14.957 | 0.287 | | | 3.848 |
| Stop | | Infinity | −0.24 | | | |
| Lens 2 | S3 | 5.418 | 0.449 | 1.681 | 18.453 | 3.566 |
| | S4 | 3.552 | 0.504 | | | 3.186 |
| Lens 3 | S5 | −28.316 | 0.319 | 1.534 | 55.656 | 3.180 |
| | S6 | −17.965 | 0.078 | | | 3.200 |
| Lens 4 | S7 | 26.148 | 0.553 | 1.584 | 28.227 | 3.418 |
| | S8 | 14.390 | 0.099 | | | 4.002 |
| Lens 5 | S9 | 79.696 | 0.37 | 1.534 | 55.656 | 4.394 |
| | S10 | −132.150 | 0.086 | | | 4.630 |
| Lens 6 | S11 | 79.956 | 0.4 | 1.534 | 55.656 | 4.796 |
| | S12 | −50.519 | 0.158 | | | 5.110 |
| Lens 7 | S13 | 4.598 | 0.451 | 1.584 | 28.227 | 5.228 |
| | S14 | 4.424 | 0.788 | | | 6.358 |
| Lens 8 | S15 | 26.728 | 1.501 | 1.534 | 55.656 | 7.294 |
| | S16 | −3.001 | 0.438 | | | 8.490 |
| Lens 9 | S17 | −5.083 | 0.804 | 1.534 | 55.656 | 10.010 |
| | S18 | 3.075 | 0.511 | | | 11.548 |
| Filter | | Infinity | 0.21 | 1.517 | 64.167 | |
| | | Infinity | 0.634 | | | |
| Image | | Infinity | | | | |
| sensor | | | | | | |

Table 6 shows, in the first to ninth lenses 110, 120, 130, 140, 150, 160, 170, 180, and 190 according to the second embodiment, the radius of curvature on the optical axis OA, the center thickness of each lens, and the distance between adjacent lenses, refractive index at the d-line, Abbe number, and a size of the effective diameter (clear aperture (CA)).

The first lens 110 of the optical system 1000 according to the second embodiment may have a positive (+) refractive power on the optical axis OA. The first surface S1 of the first lens 110 may have a convex shape on the optical axis OA, and the second surface S2 may have a concave shape on the optical axis OA. The first lens 110 may have a meniscus shape convex from the optical axis OA toward the object side. The first surface S1 and the second surface S2 may have aspheric coefficients as shown in Table 7 below.

The second lens 120 may have negative (−) refractive power on the optical axis OA. The third surface S3 of the second lens 120 may have a convex shape on the optical axis OA, and the fourth surface S4 may have a concave shape on the optical axis OA. The second lens 120 may have a meniscus shape convex from the optical axis OA toward the object side. The third surface S3 may be an aspherical surface, and the fourth surface S4 may be an aspherical surface. The third surface S3 and the fourth surface S4 may have aspheric coefficients as shown in Table 7 below.

The third lens 130 may have positive (+) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor side. The fifth surface S5 may be an aspherical surface, and the sixth surface S6 may be an aspherical surface. The fifth surface S5 and the sixth surface S6 may have aspheric coefficients as shown in Table 7 below.

The fourth lens 140 may have negative (−) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape convex from the optical axis OA toward the object side. The seventh surface S7 may be an aspherical surface, and the eighth surface S8 may be an aspherical surface. The seventh surface S7 and the eighth surface S8 may have aspheric coefficients as shown in Table 7 below.

The fifth lens 150 may have a positive (+) refractive power on the optical axis OA. The ninth surface S9 of the fifth lens 150 may have a convex shape on the optical axis OA, and the tenth surface S10 may have a convex shape on the optical axis OA. The fifth lens 150 may have a shape in which both sides are convex on the optical axis OA. The ninth surface S9 may be an aspherical surface, and the tenth surface S10 may be an aspherical surface. The ninth surface S9 and the tenth surface S10 may have aspheric coefficients as shown in Table 7 below.

The sixth lens 160 may have a positive (+) refractive power on the optical axis OA. The eleventh surface S11 of the sixth lens 160 may have a convex shape on the optical axis OA, and the twelfth surface S12 may have a convex shape on the optical axis OA. The sixth lens 160 may have a shape in which both sides are convex on the optical axis OA. The eleventh surface S11 may be an aspherical surface, and the twelfth surface S12 may be an aspherical surface. The eleventh surface S11 and the twelfth surface S12 may have aspheric coefficients as shown in Table 7 below.

The seventh lens 170 may have negative (−) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspheric coefficients as shown in Table 7 below. The seventh lens 170 may include a critical point. In detail, the above-described first critical point may be disposed on the thirteenth surface S13 of the seventh lens 170. In addition, the above-described second critical point may be disposed on the fourteenth surface S14 of the seventh lens 170.

The eighth lens 180 may have positive (+) refractive power on the optical axis OA. The fifteenth surface S15 of the eighth lens 180 may have a convex shape on the optical axis OA, and the sixteenth surface S16 may have a convex shape on the optical axis OA. The eighth lens 180 may have a shape in which both sides are convex on the optical axis OA. The fifteenth surface S15 may be an aspherical surface, and the sixteenth surface S16 may be an aspherical surface. The fifteenth surface S15 and the sixteenth surface S16 may have aspherical coefficients as shown in Table 7 below.

The ninth lens 190 may have negative (−) refractive power on the optical axis OA. The seventeenth surface S17 of the ninth lens 190 may have a concave shape on the optical axis OA, and the eighteenth surface S18 may have a concave shape on the optical axis OA. The ninth lens 190 may have a concave shape on both sides of the optical axis OA. The seventeenth surface S17 may be an aspherical surface, and the eighteenth surface S18 may be an aspherical surface. The seventeenth surface S17 and the eighteenth surface S18 may have aspheric coefficients as shown in Table 7 below. The ninth lens 190 may include a critical point. In detail, the third critical point may be disposed on the eighteenth surface S18 of the ninth lens 190.

Table 7 below shows the values of the aspheric coefficients of each lens surface in the optical system 1000 according to the second embodiment.

TABLE 7

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 1.17E−02 | −5.06E−02 | −2.38E−01 | 8.94E−01 | 0 | 0 | 0 | 0 | 0 |
| A | −1.69E−04 | −2.19E−02 | −2.35E−02 | −8.02E−03 | −7.77E−04 | 8.91E−04 | −1.43E−02 | −2.08E−02 | −2.40E−03 |
| B | 1.54E−03 | 2.92E−02 | 2.51E−02 | 4.31E−03 | 3.18E−03 | 1.45E−02 | 2.02E−02 | 1.91E−02 | 1.78E−02 |
| D | −2.44E−03 | −2.60E−02 | −1.79E−02 | −3.65E−03 | −1.59E−02 | −4.55E−02 | −4.43E−02 | −2.53E−02 | −2.55E−02 |
| E | 2.15E−03 | 1.58E−02 | 7.39E−03 | 8.00E−03 | 2.71E−02 | 6.20E−02 | 5.11E−02 | 1.77E−02 | 1.75E−02 |
| F | −1.18E−03 | −6.62E−03 | −4.79E−04 | −1.12E−02 | −2.74E−02 | −5.08E−02 | −3.64E−02 | −7.28E−03 | −6.95E−03 |
| G | 4.05E−04 | 1.84E−03 | −1.05E−03 | 9.04E−03 | 1.74E−02 | 2.65E−02 | 1.65E−02 | 1.82E−03 | 1.67E−03 |
| H | −8.46E−05 | −3.28E−04 | 5.07E−04 | −4.12E−03 | −6.71E−03 | −8.51E−03 | −4.59E−03 | −2.70E−04 | −2.42E−04 |
| I | 9.82E−06 | 3.36E−05 | −9.95E−05 | 9.91E−04 | 1.43E−03 | 1.53E−03 | 7.17E−04 | 2.10E−05 | 1.95E−05 |
| J | −4.88E−07 | −1.51E−06 | 7.44E−06 | −9.76E−05 | −1.30E−04 | −1.19E−04 | −4.79E−05 | −5.94E−07 | −6.70E−07 |
| | L5 | L6 | | L7 | | L8 | | L9 | |
| | S10 | S11 | S12 | S13 | S14 | S15 | S16 | S17 | S18 |
| K | 0 | 0 | 0 | −7.91E−01 | −1.92E+00 | −6.55E+01 | −1.11E+00 | −1.75E+00 | −9.40E+00 |
| A | −2.07E−03 | 6.96E−05 | 3.65E−05 | −2.79E−02 | −2.34E−02 | 2.22E−03 | 3.49E−02 | 9.68E−04 | −1.12E−02 |
| B | 3.80E−03 | −1.61E−03 | 1.90E−03 | 7.01E−03 | 3.73E−03 | −1.66E−03 | −1.07E−02 | −5.05E−03 | 1.52E−03 |
| D | −2.68E−03 | 2.13E−03 | −1.52E−03 | −1.75E−03 | −1.41E−04 | 3.67E−05 | 2.05E−03 | 1.21E−03 | −1.61E−04 |
| E | 6.53E−04 | −1.63E−03 | 4.88E−04 | 3.84E−05 | −2.36E−04 | 1.23E−04 | −2.30E−04 | −1.33E−04 | 1.18E−05 |
| F | 1.70E−04 | 7.32E−04 | −7.56E−05 | 1.14E−04 | 7.99E−05 | −4.10E−05 | 1.44E−05 | 8.54E−06 | −5.61E−07 |
| G | −1.49E−04 | −1.97E−04 | 6.48E−06 | −3.86E−05 | −1.25E−05 | 6.29E−06 | −3.97E−07 | −3.43E−07 | 1.50E−08 |
| H | 3.82E−05 | 3.11E−05 | −6.15E−07 | 6.35E−06 | 1.06E−06 | −5.17E−07 | −4.79E−09 | 8.48E−09 | −1.49E−10 |
| I | −4.44E−06 | −2.66E−06 | 7.49E−08 | −5.60E−07 | −4.67E−08 | 2.20E−08 | 5.70E−10 | −1.19E−10 | −1.41E−12 |
| J | 2.00E−07 | 9.55E−08 | −3.97E−09 | 2.08E−08 | 8.42E−10 | −3.83E−10 | −1.00E−11 | 7.21E−13 | 3.03E−14 |

In addition, in the optical system 1000 according to the second embodiment, the first distance d67 between the sensor-side surface of the sixth lens 160 and the object-side surface of the seventh lens 170 in a direction perpendicular to the optical axis may be as shown in Table 8 below.

TABLE 8

| Vertical height (mm) to | | Vertical height (mm) to |
|---|---|---|
| the optical axis from | | the optical axis from |
| the optical axis at the | First | the optical axis at the |
| sensor-side surface of | distance | object-side surface of |
| the sixth lens | (d67) (mm) | the seventh lens |
| 0.000 | 0.158 | 0.000 |
| 0.100 | 0.160 | 0.100 |
| 0.200 | 0.163 | 0.200 |
| 0.300 | 0.169 | 0.300 |
| 0.400 | 0.177 | 0.400 |
| 0.500 | 0.186 | 0.500 |
| 0.600 | 0.198 | 0.600 |
| 0.700 | 0.210 | 0.700 |
| 0.800 | 0.224 | 0.800 |
| 0.900 | 0.239 | 0.900 |
| 1.000 | 0.254 | 1.000 |
| 1.100 | 0.269 | 1.100 |
| 1.200 | 0.285 | 1.200 |
| 1.300 | 0.299 | 1.300 |
| 1.400 | 0.314 | 1.400 |
| 1.500 | 0.327 | 1.500 |
| 1.600 | 0.338 | 1.600 |
| 1.700 | 0.347 | 1.700 |
| 1.800 | 0.354 | 1.800 |
| 1.900 (EG1) | 0.356 | 1.900 (EG1) |
| 2.000 | 0.353 | 2.000 |
| 2.100 | 0.345 | 2.100 |
| 2.200 | 0.328 | 2.200 |
| 2.300 | 0.300 | 2.300 |
| 2.400 | 0.256 | 2.400 |
| 2.500 | 0.189 | 2.500 |
| 2.555 (EG2) | 0.089 | 2.555 (EG2) |

Referring to Table 8, the first distance may increase from the optical axis OA toward the first point EG1 located on the twelfth surface S12. When the optical axis OA is the starting point and the end of the effective region of the twelfth surface S12 is the end point, the first point EG1 may be disposed in the range of about 65% to about 85% with respect to the direction perpendicular to the optical axis OA. For example, in the second embodiment, the second point EG2 may be arranged in a range of about 74.36%. The first distance may decrease from the first point EG1 to the second point EG2 that is the end of the effective diameter of the twelfth surface S12. Here, the value of the second point EG2 is an effective radius value of the twelfth surface S12 having a smaller effective diameter of the sensor-side surface (twelfth surface S12) of the sixth lens 160 and the object-side surface S13 of the seventh lens 170 facing each other, and means ½ of the effective diameter value of the twelfth surface S12 shown in Table 6. The first distance may have a maximum value at the first point EG1 and a minimum value at the second point EG2. The maximum value of the second distance may be about 1.5 times to about 5 times the minimum value. For example, in the second embodiment, the maximum value of the first distance may be about 4.01 times the minimum value. In addition, in the optical system 1000 according to the second embodiment, the second distance d78 between the sensor-side surface of the seventh lens 170 and the object-side surface of the eighth lens 180 in a direction perpendicular to the optical axis may be as shown in Table 9 below.

TABLE 9

| Vertical height (mm) to | | Vertical height (mm) to |
|---|---|---|
| the optical axis from | | the optical axis from |
| the optical axis at the | Second | the optical axis at the |
| sensor-side surface of | distance | object-side surface of |
| the seventh lens | (d78) (mm) | the eighth lens |
| 0.000 | 0.788 | 0.000 |
| 0.100 | 0.787 | 0.100 |
| 0.200 | 0.784 | 0.200 |
| 0.300 | 0.780 | 0.300 |
| 0.400 | 0.773 | 0.400 |
| 0.500 | 0.766 | 0.500 |
| 0.600 | 0.757 | 0.600 |
| 0.700 | 0.747 | 0.700 |
| 0.800 | 0.737 | 0.800 |
| 0.900 | 0.726 | 0.900 |
| 1.000 | 0.715 | 1.000 |
| 1.100 | 0.704 | 1.100 |
| 1.200 | 0.693 | 1.200 |
| 1.300 | 0.682 | 1.300 |
| 1.400 | 0.672 | 1.400 |
| 1.500 | 0.662 | 1.500 |
| 1.600 | 0.653 | 1.600 |
| 1.700 | 0.645 | 1.700 |
| 1.800 | 0.638 | 1.800 |
| 1.900 | 0.632 | 1.900 |
| 2.000 | 0.627 | 2.000 |
| 2.100 | 0.623 | 2.100 |
| 2.200 | 0.620 | 2.200 |
| 2.300 | 0.617 | 2.300 |
| 2.400 | 0.615 | 2.400 |
| 2.500 | 0.612 | 2.500 |
| 2.600 | 0.609 | 2.600 |
| 2.700 | 0.605 | 2.700 |
| 2.800 | 0.601 | 2.800 |
| 2.900 | 0.596 | 2.900 |
| 3.000 | 0.590 | 3.000 |
| 3.100 | 0.582 | 3.100 |
| 3.179 (EG3) | 0.575 | 3.179 (EG3) |

Referring to Table 9, the second distance may decrease from the optical axis OA toward the third point EG3 located on the fourteenth surface S14. The third point EG3 may be an end of the effective region of the fourteenth surface S14. Here, the value of the third point EG3 is an effective radius value of the fourteenth surface S14 having a smaller effective diameter of the sensor-side surface (fourteenth surface S14) of the seventh lens 170 and the object-side surface (fifteenth surface S15) of the eighth lens 180 facing each other, means ½ of the effective radius value of the fourteenth surface S14 shown in Table 6. The second distance may have a maximum value at the optical axis OA and a minimum value at the third point EG3. The maximum value of the second distance may be about 1.2 times to about 2 times the minimum value. For example, in the second embodiment, the maximum value of the second distance may be about 1.37 times the minimum value. The optical system 1000 may have improved optical characteristics not only at the center portion of the field of view (FOV) but also at the periphery portion. In detail, the optical system 1000 according to the embodiment may have improved distortion control characteristics as the seventh lens 170 and the eighth lens 180 are spaced apart at distances set according to positions. In addition, in the optical system 1000 according to the second embodiment, the third distance d89 between the sensor-side surface of the eighth lens 180 and the object-side surface of the ninth lens 190 along a direction perpendicular to the optical axis may be as shown in Table 10 below.

TABLE 10

| Vertical height (mm) to | | Vertical height (mm) to |
|---|---|---|
| the optical axis from | | the optical axis from |
| the optical axis at the | Third | the optical axis at the |
| sensor-side surface of | distance | object-side surface of |
| the eighth lens | (d89) (mm) | the ninth lens |
| 0.000 | 0.438 | 0.000 |
| 0.100 | 0.439 | 0.100 |
| 0.200 | 0.441 | 0.200 |
| 0.300 | 0.444 | 0.300 |
| 0.400 | 0.448 | 0.400 |
| 0.500 | 0.453 | 0.500 |
| 0.600 | 0.458 | 0.600 |
| 0.700 | 0.464 | 0.700 |
| 0.800 | 0.469 | 0.800 |
| 0.900 | 0.474 | 0.900 |
| 1.000 | 0.477 | 1.000 |
| 1.100 | 0.479 | 1.100 |
| 1.200 (EG4) | 0.480 | 1.200 (EG4) |
| 1.300 | 0.478 | 1.300 |
| 1.400 | 0.474 | 1.400 |
| 1.500 | 0.468 | 1.500 |
| 1.600 | 0.459 | 1.600 |
| 1.700 | 0.447 | 1.700 |
| 1.800 | 0.432 | 1.800 |
| 1.900 | 0.414 | 1.900 |
| 2.000 | 0.393 | 2.000 |
| 2.100 | 0.369 | 2.100 |
| 2.200 | 0.343 | 2.200 |
| 2.300 | 0.315 | 2.300 |
| 2.400 | 0.286 | 2.400 |
| 2.500 | 0.256 | 2.500 |
| 2.600 | 0.226 | 2.600 |
| 2.700 | 0.197 | 2.700 |
| 2.800 | 0.170 | 2.800 |
| 2.900 | 0.146 | 2.900 |
| 3.000 | 0.126 | 3.000 |
| 3.100 | 0.110 | 3.100 |
| 3.200 | 0.100 | 3.200 |
| 3.300 (EG5) | 0.097 | 3.300 (EG5) |
| 3.400 | 0.100 | 3.400 |
| 3.500 | 0.111 | 3.500 |
| 3.600 | 0.130 | 3.600 |
| 3.700 | 0.158 | 3.700 |
| 3.800 | 0.194 | 3.800 |
| 3.900 | 0.239 | 3.900 |
| 4.000 | 0.288 | 4.000 |
| 4.100 | 0.339 | 4.100 |
| 4.200 | 0.385 | 4.200 |
| 4.245 (EG6) | 0.418 | 4.245 (EG6) |

Referring to Table 10, the third distance may increase from the optical axis OA toward the fourth point EG4 located on the sixteenth surface S16. When the optical axis OA is the starting point and an end of the effective region of the sixteenth surface S16 is the endpoint, the fourth point EG4 may be disposed in the range of about 20% to about 35% with respect to the direction perpendicular to the optical axis OA. For example, in the second embodiment, the fourth point EG4 may be disposed at about 28.27%. Also, the third distance may decrease from the fourth point EG4 to a fifth point EG5 located on the sixteenth surface S16. When the optical axis OA is the starting point and an end of the effective region of the sixteenth surface S16 is the end point, the fifth point EG5 may be disposed in the range of about 70% to about 80% with respect to the direction perpendicular to the optical axis OA. For example, in the second embodiment, the fifth point EG5 may be disposed at a position of about 77.7%. Also, the third distance may increase from the fifth point EG5 toward the sixth point EG6 that is the end of the effective diameter of the sixteenth surface S16. Here, the value of the sixth point EG6 is an effective radius value of the sixteenth surface S16 having a smaller effective diameter of the sensor-side surface (sixteenth surface S16) of the eighth lens 180 and the object-side surface (seventeenth surface S17) of the ninth lens 190 facing each other, and means ½ of the effective diameter value of the sixteenth surface S16 described in Table 6. The third distance may have a maximum value at the fourth point EG4 and a minimum value at the fifth point EG5. The maximum value of the third distance may be about 4 times to about 6 times the minimum value. For example, in the first embodiment, the maximum value of the third distance may be about 4.96 times the minimum value. The optical system 1000 may have improved optical characteristics not only at the center portion of the field of view (FOV) but also at the periphery portion. In detail, the optical system 1000 according to the embodiment may have improved distortion control characteristics as the eighth lens 180 and the ninth lens 190 are spaced apart at distances set according to positions. The optical system 1000 according to the second embodiment may have good optical performance at the center portion and periphery portion of the field of view (FOV), and may have excellent optical properties as shown in FIGS. 6 to 8. In detail, FIG. 6 is a graph of an aberration diagram of the optical system 1000 according to the second embodiment, in which spherical aberration (Longitudinal spherical aberration), astigmatic field curves, and distortion are measured from left to right. In FIG. 6, the X-axis may indicate a focal length (mm) or distortion (%), and the Y-axis may indicate the height of an image. In addition, the graph for spherical aberration is a graph for light in a wavelength band of about 435 nm, about 486 nm, about 546 nm, about 587 nm, and about 656 nm, and the graph for astigmatism and distortion aberration is a graph for light in the wavelength band of 546 nm.

FIG. 7 is a view showing a distortion grid of the optical system 1000 according to the first embodiment, and the optical system 1000 may have the same distortion characteristics as in FIG. 7. FIG. 8 is a graph showing coma aberration of the optical system 1000 according to the second embodiment, and is a graph of measuring the aberration of the tangential component and the sagittal component of the light in wavelength bands of about 435 nm, about 486 nm, about 546 nm, about 587 nm, and about 656 nm depending on the field height of the image. The interpretation of the coma graph may be interpreted that the closer the X-axis on the positive and negative axes, the better the coma correction function. That is, referring to FIGS. 6 to 8, the optical system 1000 according to the first embodiment has improved resolution as the plurality of lenses 100 have a set shape, focal length, set distance, and the like, and the angle of view (FOV) and may provide good optical performance not only at the center portion but also at the periphery portion.

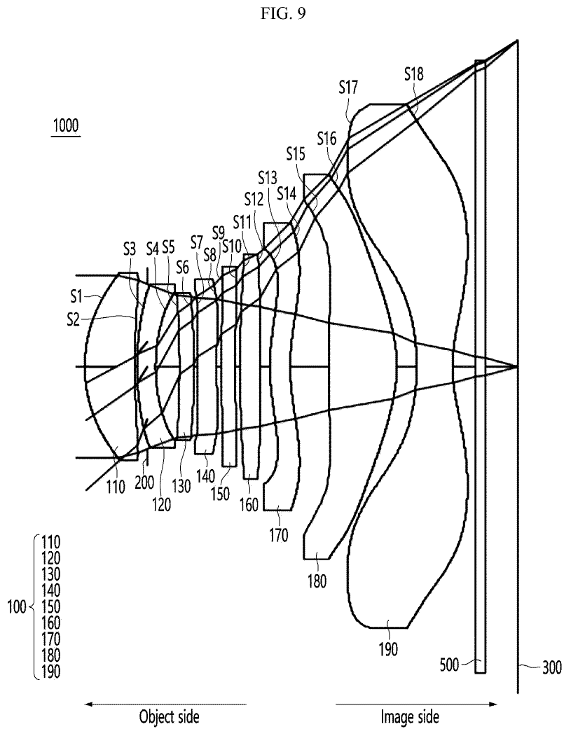

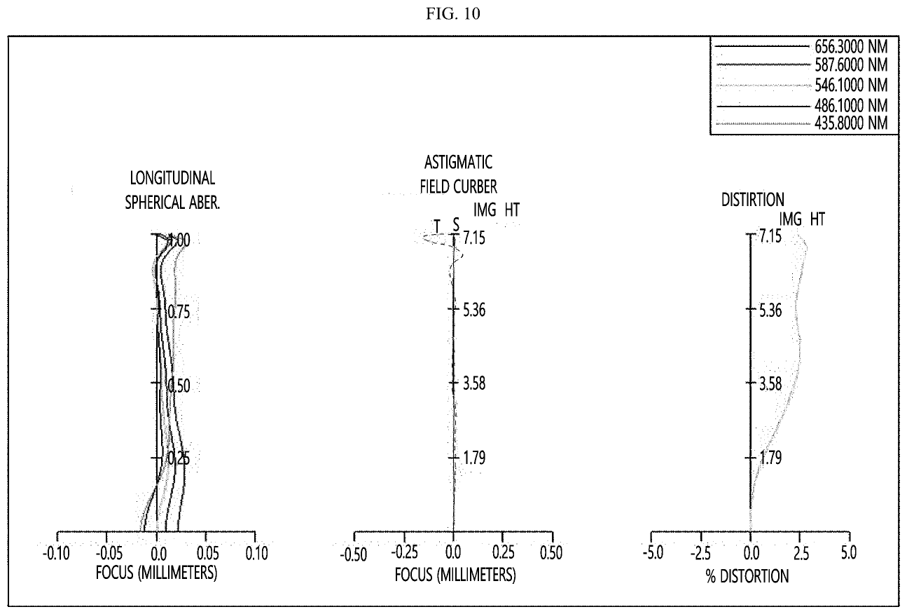

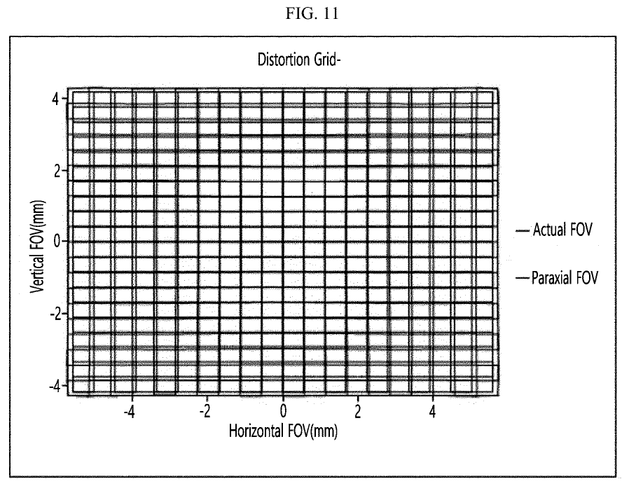

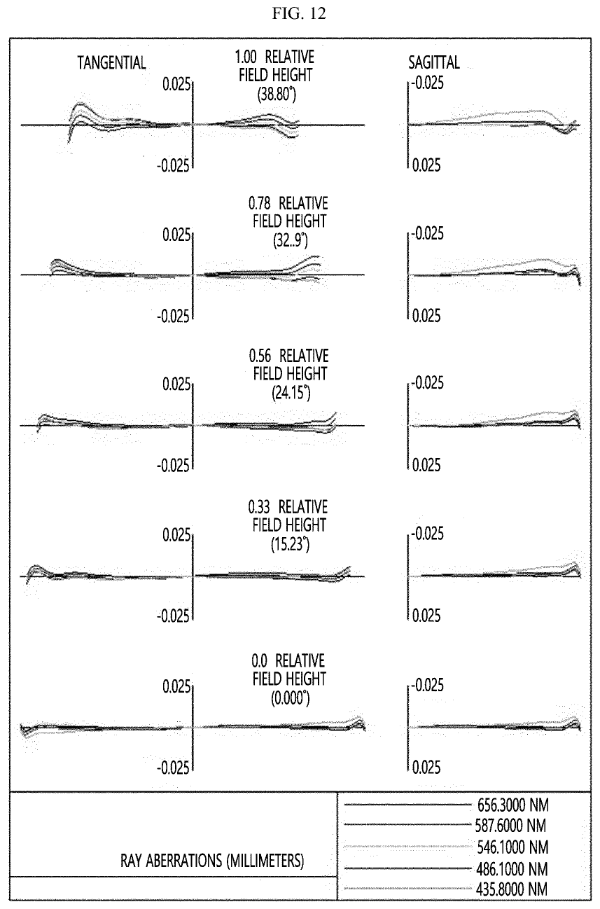

FIG. 9 is a configuration diagram of an optical system according to the third embodiment, and FIG. 10 is a graph showing an aberration diagram of the optical system according to the third embodiment. FIG. 11 is a view showing a distortion grid of the optical system according to the third embodiment, and FIG. 12 is a graph showing coma aberration of the optical system according to the third embodiment.

Referring to FIGS. 9 to 12, the optical system 1000 according to the third embodiment may include the first lens 110 to the ninth lens 190 and the image sensor 300 sequentially arranged from the object side to the sensor side. The first to ninth lenses 110, 120, 130, 140, 150, 160, 170, 180 and 190 may be sequentially disposed along the optical axis OA of the optical system 1000. In the optical system 1000 according to the third embodiment, an aperture stop may be disposed between the first lens 110 and the second lens 120. Also, a filter 500 may be disposed between the plurality of lenses 100 and the image sensor 300. In detail, the filter 500 may be disposed between the ninth lens 190 and the image sensor 300.

TABLE 11

| | | Radius of | Thickness (mm)/ | Reflective | Abbe | Effective |
|---|---|---|---|---|---|---|
| Lens | Surface | curvature | Distance (mm) | Index | number | diameter (mm) |
| Lens 1 | S1 | 3.080 | 1.098 | 1.534 | 55.656 | 4.124 |
| | S2 | 14.848 | 0.287 | | | 3.852 |
| Stop | | Infinity | −0.24 | | | |
| Lens 2 | S3 | 5.453 | 0.408 | 1.681 | 18.453 | 3.596 |
| | S4 | 3.620 | 0.523 | | | 3.236 |
| Lens 3 | S5 | −27.070 | 0.318 | 1.544 | 56.115 | 3.224 |
| | S6 | −18.824 | 0.077 | | | 3.200 |
| Lens 4 | S7 | 23.370 | 0.421 | 1.681 | 18.453 | 3.396 |
| | S8 | 15.937 | 0.11 | | | 3.824 |
| Lens 5 | S9 | 155.279 | 0.302 | 1.567 | 37.565 | 4.164 |
| | S10 | 82.372 | 0.1 | | | 4.410 |
| Lens 6 | S11 | 30.715 | 0.45 | 1.544 | 56.115 | 4.654 |
| | S12 | −61.818 | 0.205 | | | 4.946 |
| Lens 7 | S13 | 4.548 | 0.443 | 1.588 | 28.269 | 5.178 |
| | S14 | 4.397 | 0.842 | | | 6.320 |
| Lens 8 | S15 | 29.173 | 1.495 | 1.544 | 56.115 | 7.346 |
| | S16 | −2.999 | 0.438 | | | 8.470 |
| Lens 9 | S17 | −5.007 | 0.784 | 1.534 | 55.656 | 10.010 |
| | S18 | 3.137 | 0.511 | | | 11.488 |
| Filter | | Infinity | 0.21 | 1.517 | 64.167 | |
| | | Infinity | 0.72 | | | |
| Image | | Infinity | | | | |
| sensor | | | | | | |

Table 11 shows, in the first to ninth lenses 110, 120, 130, 140, 150, 160, 170, 180, and 190 according to the third embodiment, the radius of curvature on the optical axis OA, the center thickness of the lenses, and the center distance between adjacent lenses, refractive index at the d-line, Abbe number, and a size of the effective diameter (clear aperture (CA)). The first lens 110 of the optical system 1000 according to the third exemplary embodiment may have positive (+) refractive power on the optical axis OA. The first surface S1 of the first lens 110 may have a convex shape on the optical axis OA, and the second surface S2 may have a concave shape on the optical axis OA. The first lens 110 may have a meniscus shape convex from the optical axis OA toward the object side. The first surface S1 and the second surface S2 may have aspheric coefficients as shown in Table 12 below.

The second lens 120 may have negative (−) refractive power on the optical axis OA. The third surface S3 of the second lens 120 may have a convex shape on the optical axis OA, and the fourth surface S4 may have a concave shape on the optical axis OA. The second lens 120 may have a meniscus shape convex from the optical axis OA toward the object side. The third surface S3 may be an aspherical surface, and the fourth surface S4 may be an aspherical surface. The third surface S3 and the fourth surface S4 may have aspheric coefficients as shown in Table 12 below.

The third lens 130 may have positive (+) refractive power on the optical axis OA. The fifth surface S5 of the third lens 130 may have a concave shape on the optical axis OA, and the sixth surface S6 may be convex on the optical axis OA. The third lens 130 may have a meniscus shape convex from the optical axis OA toward the sensor. The fifth surface S5 may be an aspherical surface, and the sixth surface S6 may be an aspherical surface. The fifth surface S5 and the sixth surface S6 may have aspheric coefficients as shown in Table 12 below.

The fourth lens 140 may have negative (−) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape convex from the optical axis OA toward the object side. The seventh surface S7 may be an aspherical surface, and the eighth surface S8 may be an aspherical surface. The seventh surface S7 and the eighth surface S8 may have aspheric coefficients as shown in Table 12 below.

The fifth lens 150 may have negative (−) refractive power on the optical axis OA. The ninth surface S9 of the fifth lens 150 may have a convex shape on the optical axis OA, and the tenth surface S10 may have a concave shape on the optical axis OA. The fifth lens 150 may have a meniscus shape convex from the optical axis OA toward the object side. The ninth surface S9 may be an aspherical surface, and the tenth surface S10 may be an aspherical surface. The ninth surface S9 and the tenth surface S10 may have aspheric coefficients as shown in Table 12 below.

The sixth lens 160 may have a positive (+) refractive power on the optical axis OA. The eleventh surface S11 of the sixth lens 160 may have a convex shape on the optical axis OA, and the twelfth surface S12 may have a convex shape on the optical axis OA. The sixth lens 160 may have a shape in which both sides are convex on the optical axis OA. The eleventh surface S11 may be an aspherical surface, and the twelfth surface S12 may be an aspherical surface. The eleventh surface S11 and the twelfth surface S12 may have aspheric coefficients as shown in Table 12 below.

The seventh lens 170 may have a positive (+) refractive power on the optical axis OA. The thirteenth surface S13 of the seventh lens 170 may have a convex shape on the optical axis OA, and the fourteenth surface S14 may have a concave shape on the optical axis OA. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have aspheric coefficients as shown in Table 12 below. The seventh lens 170 may include a critical point. In detail, the above-described first critical point may be disposed on the thirteenth surface S13 of the seventh lens 170. In addition, the above-described second critical point may be disposed on the fourteenth surface S14 of the seventh lens 170.

The eighth lens 180 may have positive (+) refractive power on the optical axis OA. The fifteenth surface S15 of the eighth lens 180 may have a convex shape on the optical axis OA, and the sixteenth surface S16 may have a convex shape on the optical axis OA. The eighth lens 180 may have a shape in which both sides are convex on the optical axis OA. The fifteenth surface S15 may be an aspherical surface, and the sixteenth surface S16 may be an aspherical surface. The fifteenth surface S15 and the sixteenth surface S16 may have aspheric coefficients as shown in Table 12 below.

The ninth lens 190 may have negative (−) refractive power on the optical axis OA. The seventeenth surface S17 of the ninth lens 190 may have a concave shape on the optical axis OA, and the eighteenth surface S18 may have a concave shape on the optical axis OA. The ninth lens 190 may have a concave shape on both sides of the optical axis OA. The seventeenth surface S17 may be an aspherical surface, and the eighteenth surface S18 may be an aspherical surface. The seventeenth surface S17 and the eighteenth surface S18 may have aspheric coefficients as shown in Table 12 below. The ninth lens 190 may include a critical point. In detail, the third critical point may be disposed on the eighteenth surface S18 of the ninth lens 190.

The values of the aspheric coefficients of each lens surface in the optical system 1000 according to the third embodiment are shown in Table 12 below.

TABLE 12

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| K | 1.14.E−02 | 1.02.E+00 | −1.94.E−01 | 9.02.E−01 | 0 | 0 | 0 | 0 | 0 |
| A | 6.53.E−06 | −2.28.E−02 | −2.51.E−02 | −8.11.E−03 | −9.25.E−04 | 5.37.E−04 | −1.51.E−02 | −1.84.E−02 | 1.76.E−03 |
| B | 8.81.E−04 | 3.20.E−02 | 2.88.E−02 | 1.28.E−03 | 2.77.E−03 | 1.93.E−02 | 2.21.E−02 | 1.41.E−02 | 7.73.E−03 |
| D | −1.42.E−03 | −2.95.E−02 | −2.25.E−02 | 7.41.E−03 | −1.34.E−02 | −5.48.E−02 | −4.71.E−02 | −2.28.E−02 | −1.73.E−02 |
| E | 1.26.E−03 | 1.86.E−02 | 1.14.E−02 | −1.12.E−02 | 2.16.E−02 | 6.89.E−02 | 5.16.E−02 | 1.95.E−02 | 1.54.E−02 |
| F | −7.06.E−04 | −8.09.E−03 | −2.92.E−03 | 8.36.E−03 | −2.04.E−02 | −5.21.E−02 | −3.48.E−02 | −9.78.E−03 | −7.69.E−03 |
| G | 2.47.E−04 | 2.34.E−03 | −6.97.E−05 | −3.18.E−03 | 1.23.E−02 | 2.51.E−02 | 1.49.E−02 | 3.00.E−03 | 2.32.E−03 |
| H | −5.30.E−05 | −4.31.E−04 | 2.59.E−04 | 4.73.E−04 | −4.54.E−03 | −7.50.E−03 | −3.95.E−03 | −5.53.E−04 | −4.22.E−04 |
| I | 6.31.E−06 | 4.56.E−05 | −6.35.E−05 | 3.78.E−05 | 9.32.E−04 | 1.27.E−03 | 5.91.E−04 | 5.54.E−05 | 4.26.E−05 |
| J | −3.21.E−07 | −2.12.E−06 | 5.16.E−06 | −1.37.E−05 | −8.18.E−05 | −9.26.E−05 | −3.81.E−05 | −2.25.E−06 | 1.85.E−06 |
| | L5 | L6 | | L7 | | L8 | | L9 | |
| | S10 | S11 | S12 | S13 | S14 | S15 | S16 | S17 | S18 |
| K | 0. | 0 | 0 | 0 | −1.84.E+00 | −6.35.E+01 | −1.10.E+00 | −1.79.E+00 | −9.34.E+00 |
| A | −1.56.E−03 | −8.83.E−04 | −2.62.E−05 | −2.74.E−02 | −2.34.E−02 | 1.72.E−03 | 3.38.E−02 | 9.75.E−04 | −1.16.E−02 |
| B | 3.49.E−03 | 2.13.E−03 | 2.36.E−03 | 6.58.E−03 | 3.92.E−03 | −1.27.E−03 | −9.99.E−03 | −5.06.E−03 | 1.57.E−03 |
| D | −4.23.E−03 | −2.52.E−03 | −2.33.E−03 | −1.74.E−03 | −3.29.E−04 | −9.18.E−05 | 1.86.E−03 | 1.21.E−03 | −1.70.E−04 |
| E | 2.98.E−03 | 1.43.E−03 | 8.94.E−04 | 1.45.E−04 | −1.40.E−04 | 1.42.E−04 | −2.01.E−04 | −1.32.E−04 | 1.31.E−05 |
| F | −1.29.E−03 | −4.64.E−04 | −1.75.E−04 | 6.08.E−05 | 5.35.E−05 | −4.11.E−05 | 1.17.E−05 | 8.44.E−06 | −6.77.E−07 |
| G | 3.47.E−04 | 9.42.E−05 | 2.03.E−05 | −2.62.E−05 | −8.24.E−06 | 5.94.E−06 | −2.37.E−07 | −3.36.E−07 | 2.10.E−08 |
| H | −5.64.E−05 | −1.26.E−05 | −1.88.E−06 | 4.84.E−06 | 6.63.E−07 | −4.69.E−07 | −1.02.E−08 | 8.22.E−09 | −3.28.E−10 |
| I | 5.14.E−06 | 1.04.E−06 | 1.64.E−07 | −4.68.E−07 | −2.72.E−08 | 1.94.E−08 | 6.59.E−10 | −1.14.E−10 | 1.45.E−12 |
| J | −2.04.E−07 | −3.95.E−08 | −7.76.E−09 | 1.86.E−08 | 4.40.E−10 | −3.27.E−10 | −1.04.E−11 | 6.86.E−13 | 1.15.E−14 |

The first distance d67 between the sensor-side surface of the sixth lens 160 and the object-side surface of the seventh lens 170 along the direction perpendicular to the optical axis in the optical system 1000 according to the third embodiment may be shown in the table 13 below.

TABLE 13

| Vertical height (mm) to | | Vertical height (mm) to |
|---|---|---|
| the optical axis from | | the optical axis from |
| the optical axis at the | First | the optical axis at the |
| sensor-side surface of | distance | object-side surface of |
| the sixth lens | (d67) (mm) | the seventh lens |
| 0.000 | 0.205 | 0.000 |
| 0.100 | 0.207 | 0.100 |
| 0.200 | 0.210 | 0.200 |
| 0.300 | 0.216 | 0.300 |
| 0.400 | 0.224 | 0.400 |
| 0.500 | 0.233 | 0.500 |
| 0.600 | 0.245 | 0.600 |
| 0.700 | 0.257 | 0.700 |
| 0.800 | 0.271 | 0.800 |
| 0.900 | 0.286 | 0.900 |
| 1.000 | 0.301 | 1.000 |
| 1.100 | 0.316 | 1.100 |
| 1.200 | 0.331 | 1.200 |
| 1.300 | 0.346 | 1.300 |
| 1.400 | 0.361 | 1.400 |
| 1.500 | 0.374 | 1.500 |
| 1.600 | 0.386 | 1.600 |
| 1.700 | 0.396 | 1.700 |
| 1.800 | 0.403 | 1.800 |
| 1.900 (EG1) | 0.406 | 1.900 (EG1) |
| 2.000 | 0.404 | 2.000 |
| 2.100 | 0.396 | 2.100 |
| 2.200 | 0.379 | 2.200 |
| 2.300 | 0.351 | 2.300 |
| 2.400 | 0.307 | 2.400 |
| 2.473 (EG2) | 0.238 | 2.473 (EG2) |

Referring to Table 13, the first distance may increase from the optical axis OA toward the first point EG1 located on the twelfth surface S12. When the optical axis OA is the starting point and the effective region end of the twelfth surface S12 is the end point, the first point EG1 may be disposed in the range of about 65% to about 85% with respect to the direction perpendicular to the optical axis OA. For example, in the third embodiment, the second point EG2 may be disposed at a position of about 76.83%. The first distance may decrease from the first point EG1 to the second point EG2 that is an effective radius value of the twelfth surface S12 having a smaller effective diameter of the sensor-side surface (twelfth surface S12) of the sixth lens 160 and the object-side surface S13 of the seventh lens 170 facing each other, and means ½ of the effective diameter value of the twelfth surface S12 shown in Table 11. The first distance may have a maximum value at the first point EG1 and a minimum value at the optical axis OA. The maximum value of the second distance may be about 1.5 times to about 5 times the minimum value. For example, in the third embodiment, the maximum value of the first distance may be about 1.97 times the minimum value. In addition, in the optical system 1000 according to the third embodiment, the distance (second distance) between the sensor-side surface of the seventh lens 170 and the object-side surface of the eighth lens 180 along a direction perpendicular to the optical axis may be as shown in Table 14 below.

TABLE 14

| Vertical height (mm) to | | Vertical height (mm) to |
|---|---|---|
| the optical axis from | | the optical axis from |
| the optical axis at the | Second | the optical axis at the |
| sensor-side surface of | distance | object-side surface of |
| the seventh lens | (d78) (mm) | the eighth lens |
| 0.000 | 0.842 | 0.000 |
| 0.100 | 0.841 | 0.100 |
| 0.200 | 0.838 | 0.200 |
| 0.300 | 0.833 | 0.300 |
| 0.400 | 0.827 | 0.400 |
| 0.500 | 0.819 | 0.500 |
| 0.600 | 0.810 | 0.600 |
| 0.700 | 0.800 | 0.700 |
| 0.800 | 0.790 | 0.800 |
| 0.900 | 0.778 | 0.900 |
| 1.000 | 0.767 | 1.000 |
| 1.100 | 0.755 | 1.100 |
| 1.200 | 0.744 | 1.200 |
| 1.300 | 0.732 | 1.300 |
| 1.400 | 0.721 | 1.400 |
| 1.500 | 0.711 | 1.500 |
| 1.600 | 0.701 | 1.600 |
| 1.700 | 0.692 | 1.700 |
| 1.800 | 0.684 | 1.800 |
| 1.900 | 0.677 | 1.900 |
| 2.000 | 0.671 | 2.000 |
| 2.100 | 0.666 | 2.100 |
| 2.200 | 0.661 | 2.200 |
| 2.300 | 0.656 | 2.300 |
| 2.400 | 0.652 | 2.400 |
| 2.500 | 0.647 | 2.500 |
| 2.600 | 0.641 | 2.600 |
| 2.700 | 0.635 | 2.700 |
| 2.800 | 0.628 | 2.800 |
| 2.900 | 0.620 | 2.900 |
| 3.000 | 0.610 | 3.000 |
| 3.100 | 0.599 | 3.100 |
| 3.160 (EG3) | 0.588 | 3.160 (EG3) |

Referring to Table 14, the second distance may decrease from the optical axis OA toward the third point EG3 located on the fourteenth surface S14. The third point EG3 may be an end of the effective region of the fourteenth surface S14. Here, the value of the third point EG3 is an effective radius value of the fourteenth surface S14 having a smaller effective diameter of the fourteenth surface S14 of the seventh lens 170 and the fifteenth surface S15 of the eighth lens 180 facing each other, means ½ of the effective radius value of the fourteenth surface S14 shown in Table 11. The second distance may have a maximum value at the optical axis OA and a minimum value at the third point EG3. The maximum value of the second distance may be about 1.2 times to about 2 times the minimum value. For example, in the third embodiment, the maximum value of the second distance may be about 1.43 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the seventh lens 170 and the eighth lens 180 are spaced apart at distances set according to positions. In addition, in the optical system 1000 according to the third embodiment, the third distance d89 between the sensor-side surface of the eighth lens 180 and the object-side surface of the ninth lens 190 along a direction perpendicular to the optical axis may be as shown in Table 15 below.

TABLE 15

| Vertical height (mm) to | | Vertical height (mm) to |
|---|---|---|
| the optical axis from | | the optical axis from |
| the optical axis at the | Third | the optical axis at the |
| sensor-side surface of | distance | object-side surface of |
| the eighth lens | (d89) (mm) | the ninth lens |
| 0.000 | 0.438 | 0.000 |
| 0.100 | 0.438 | 0.100 |
| 0.200 | 0.440 | 0.200 |
| 0.300 | 0.443 | 0.300 |
| 0.400 | 0.448 | 0.400 |
| 0.500 | 0.452 | 0.500 |
| 0.600 | 0.458 | 0.600 |
| 0.700 | 0.463 | 0.700 |
| 0.800 | 0.468 | 0.800 |
| 0.900 | 0.473 | 0.900 |
| 1.000 | 0.476 | 1.000 |
| 1.100 | 0.478 | 1.100 |
| 1.200 (EG4) | 0.479 | 1.200 (EG4) |
| 1.300 | 0.477 | 1.300 |
| 1.400 | 0.473 | 1.400 |
| 1.500 | 0.466 | 1.500 |
| 1.600 | 0.457 | 1.600 |
| 1.700 | 0.444 | 1.700 |
| 1.800 | 0.429 | 1.800 |
| 1.900 | 0.411 | 1.900 |
| 2.000 | 0.389 | 2.000 |
| 2.100 | 0.365 | 2.100 |
| 2.200 | 0.339 | 2.200 |
| 2.300 | 0.311 | 2.300 |
| 2.400 | 0.281 | 2.400 |
| 2.500 | 0.251 | 2.500 |
| 2.600 | 0.221 | 2.600 |
| 2.700 | 0.192 | 2.700 |
| 2.800 | 0.165 | 2.800 |
| 2.900 | 0.142 | 2.900 |
| 3.000 | 0.122 | 3.000 |
| 3.100 | 0.107 | 3.100 |
| 3.200 | 0.098 | 3.200 |
| 3.300 (EG5) | 0.096 | 3.300 (EG5) |
| 3.400 | 0.100 | 3.400 |
| 3.500 | 0.113 | 3.500 |
| 3.600 | 0.133 | 3.600 |
| 3.700 | 0.163 | 3.700 |
| 3.800 | 0.202 | 3.800 |
| 3.900 | 0.249 | 3.900 |
| 4.000 | 0.303 | 4.000 |
| 4.100 | 0.359 | 4.100 |
| 4.200 | 0.408 | 4.200 |
| 4.235 (EG6) | 0.441 | 4.235 (EG6) |

Referring to Table 15, the third distance may increase from the optical axis OA toward the fourth point EG4 located on the sixteenth surface S16. When the optical axis OA is the starting point and the end point of the effective region of the sixteenth surface S16 is the end point, the fourth point EG4 may be disposed in the range of about 20% to about 35% of the effective radius of the sixteenth surface S16 with respect to the optical axis OA. For example, in the third embodiment, the fourth point EG4 may be disposed at a position of about 28.3%. Also, the third distance may decrease from the fourth point EG4 toward a fifth point EG5 located on the sixteenth surface S16. When the optical axis OA is the starting point and the end point of the effective region of the sixteenth surface S16 is the end point, the fifth point EG5 may be disposed in the range of about 70% to 80% of the effective radius of the sixteenth surface S16 with respect to the optical axis OA. For example, in the third embodiment, the fifth point EG5 may be disposed at a position that is about 77.9% of the effective radius of the sixteenth surface S16 with respect to the optical axis OA. Also, the third distance may increase from the fifth point EG5 to the sixth point EG6 that is the end of the effective diameter of the sixteenth surface S16. Here, the value of the sixth point EG6 is is an effective radius value of the sixteenth surface S16 having a smaller effective diameter of the sixteenth surface S16 of the eighth lens 180 and the seventeenth surface S17 of the ninth lens 190 facing each other, and means ½ of the effective diameter value of the sixteenth surface S16 described in Table 11. The third distance may have a maximum value at the fourth point EG4 and a minimum value at the fifth point EG5. The maximum value of the third distance may be about 4 times to about 6 times the minimum value. For example, in the third embodiment, the maximum value of the third distance may be about 5 times the minimum value. Accordingly, the optical system 1000 may have improved optical properties not only in the central portion of the field of view (FOV) but also in the peripheral portion. In detail, the optical system 1000 according to the embodiment may have improved distortion control characteristics as the eighth lens 180 and the ninth lens 190 are spaced apart at distances set according to positions. In detail, FIG. 10 is a graph of the aberration diagram of the optical system 1000 according to the third embodiment, in which spherical aberration (Longitudinal spherical aberration), astigmatic field curves, and distortion are measured from left to right. In FIG. 10, the X-axis may indicate a focal length (mm) or distortion (%), and the Y-axis may indicate the height of an image. In addition, the graph for spherical aberration is a graph for light in a wavelength band of about 435 nm, about 486 nm, about 546 nm, about 587 nm, and about 656 nm, and the graph for astigmatism and distortion aberration is a graph for light in the wavelength band of 546 nm.

FIG. 11 is a view showing a distortion grid of the optical system 1000 according to the third embodiment, and the optical system 1000 may have the same distortion characteristics as in FIG. 11. FIG. 12 is a graph showing coma aberration of the optical system 1000 according to the third embodiment, and is a graph of measuring the aberration of the tangential component and the sagittal component of the light in wavelength bands of about 435 nm, about 486 nm, about 546 nm, about 587 nm, and about 656 nm depending on the field height of the image. The interpretation of the coma graph may be interpreted that the closer the X-axis on the positive and negative axes, the better the coma correction function.

Referring to FIGS. 10 to 12, the optical system 1000 according to the third embodiment has improved resolution as the plurality of lenses 100 have a set shape, focal length, set distance, and the like, and the angle of view (FOV) and may provide good optical performance not only at the center portion but also at the periphery portion.

TABLE 16

| | First | | Second | | Third | |
|---|---|---|---|---|---|---|
| Item | embodiment | | embodiment | | embodiment | |
| F | 7.6871 | mm | 7.742 | mm | 7.794 | mm |
| f1 | 6.835 | mm | 6.988 | mm | 7.014 | mm |
| f2 | −16.135 | mm | −16.601 | mm | −17.183 | mm |
| f3 | 75.701 | mm | 90.614 | mm | 111.556 | mm |
| f4 | −45.798 | mm | −55.28 | mm | −74.433 | mm |
| f5 | 41.798 | mm | 92.704 | mm | −307.921 | mm |
| f6 | 155.199 | mm | 57.756 | mm | 37.612 | mm |
| f7 | −750.713 | mm | −4876.616 | mm | 2416.637 | mm |
| f8 | 4.994 | mm | 5.119 | mm | 5.059 | mm |
| f9 | −3.377 | mm | −3.452 | mm | −3.477 | mm |
| f12 | 10.023 | mm | 10.185 | mm | 10.48 | mm |
| L8_ET | 0.543 | mm | 0.555 | mm | 0.53 | mm |
| Inf71 | 1.846 | mm | 1.832 | mm | 1.828 | mm |
| Inf72 | 2.086 | mm | 2.058 | mm | 2.094 | mm |
| Inf92 | 2.748 | mm | 2.728 | mm | 2.632 | mm |
| T11 | 0.754 | mm | 0.763 | mm | 0.761 | mm |
| T91 | 1.525 | mm | 1.501 | mm | 1.497 | mm |
| T92 | 1 | mm | 0.983 | mm | 0.999 | mm |
| CA_max | 11.584 | mm | 11.548 | mm | 11.488 | mm |
| CA_min | 3.182 | mm | 3.180 | mm | 3.2 | mm |
| CA_aver | 5.362 | mm | 5.355 | mm | 5.302 | mm |
| BFL | 1.356 | mm | 1.354 | mm | 1.44 | mm |
| TTL | 9.5 | mm | 9.5 | mm | 9.5 | mm |
| ImgH | 7.15 | mm | 7.15 | mm | 7.15 | mm |

Table 16 relates to the items of the above-described equations in the optical system 1000 according to the first to third embodiments, and in the optical system 1000, it relates to the total track length (TTL), back focal length (BFL), F value, ImgH, the focal lengths f1, f2, f3, f4, f5, f6, f7, f8, and f9 of each of the first to ninth lenses 110, 120, 130, 140, 150, 160, 170, 180, and 190, and edge thickness (ET). Here, the edge thickness of the lens means the thickness in the direction of the optical axis OA at the end of the effective region of the lens. In detail, the edge thickness of the lens means the distance in a direction of the optical axis OA from the end of the effective region on the object side of the lens to the end of the effective region on the sensor side.

TABLE 17

| | | First | Second | Third |
|---|---|---|---|---|
| | | embodi- | embodi- | embodi- |
| Equation | | ment | ment | ment |
| 1 | 0.5 < f1/F < 2 | 0.889 | 0.903 | 0.900 |
| 2 | −5 < f1/f2 < 0 | −0.424 | −0.421 | −0.408 |
| 3 | 0.5 < f12/F < 5 | 1.304 | 1.316 | 1.302 |
| 4 | 0.3 < f1/f12 < 3 | 0.682 | 0.686 | 0.691 |
| 5 | 0 < LIR1/L1R2\| < 1 | 0.195 | 0.206 | 0.207 |
| 6 | 0 < L2R2/\|L2R1\| < 1 | 0.640 | 0.656 | 0.664 |
| 7 | 0.8 < n1d/n2d < 1.2 | 0.924 | 0.913 | 0.913 |
| 8 | 0.8 < n8d/n7d < 1.2 | 0.972 | 0.968 | 0.972 |
| 9 | 0.1 < L2_CT/L1_CT < 0.8 | 0.392 | 0.407 | 0.372 |
| 10 | 0.1 < L7_CT/L8_CT < 0.8 | 0.296 | 0.300 | 0.296 |
| 11 | 0.2 < L8_ET/L8_CT < 0.8 | 0.362 | 0.370 | 0.355 |
| 12 | 1.5 < L8_CT/L9_CT < 2 | 1.894 | 1.867 | 1.907 |
| 13 | 0.5 < Inf71/Inf72 < 1.2 | 0.885 | 0.890 | 0.873 |
| 14 | 0.4 < Inf71/Inf92 < 1 | 0.672 | 0.672 | 0.695 |
| 15 | 0.4 < Inf72/Inf92 < 1 | 0.759 | 0.754 | 0.796 |
| 16 | 0.1 < T11/D11 < 0.5 | 0.366 | 0.370 | 0.369 |
| 17 | 0 < T91/D91 < 0.6 | 0.305 | 0.300 | 0.299 |
| 18 | 0 < T92/D92 < 0.5 | 0.173 | 0.170 | 0.174 |
| 19 | 1 < CA_LIS1/CA_L3S1 < 2 | 1.296 | 1.297 | 1.279 |
| 20 | 2 < CA_L9S2/CA_LIS1 < 5 | 2.809 | 2.800 | 2.786 |
| 21 | 2 < L1_CT/d12_CT < 5 | 3.875 | 3.840 | 3.826 |
| 22 | 0.1 < L7_CT/d78_CT < 0.8 | 0.564 | 0.572 | 0.526 |
| 23 | 1.2 < L8_CT/d78_CT < 2.5 | 1.909 | 1.905 | 1.776 |
| 24 | 1 < d78_CT/d78_ET < 1.8 | 1.408 | 1.370 | 1.432 |
| 25 | 2 < L6_CT/d67_CT < 3 | 2.878 | 2.532 | 2.195 |
| 26 | 1.5 < L7_CT/d67_CT < 4 | 3.194 | 2.854 | 2.161 |
| 27 | 0.5 < d67_CT/ d67_ET < 2.5 | 1.137 | 1.783 | 0.862 |
| 28 | 0.5 < CA_max/(2 * ImgH) < 1 | 0.810 | 0.808 | 0.803 |
| 29 | 1.5 < CA_max/CA_aver < 3 | 0.216 | 2.157 | 2.167 |
| 30 | 0.5 < CA_min/CA_aver < 1 | 0.593 | 0.594 | 0.604 |
| 31 | 2 < TTL < 20 | Satis- | Satis- | Satis- |
| | | faction | faction | faction |
| 32 | 2 < ImgH | Satis- | Satis- | Satis- |
| | | faction | faction | faction |
| 33 | BFL < 2.5 | Satis- | Satis- | Satis- |
| | | faction | faction | faction |
| 34 | 1 < TTL/ImgH < 2 | 1.329 | 1.329 | 1.329 |
| 35 | 0.1 < BFL/ImgH < 0.5 | 0.190 | 0.189 | 0.201 |
| 36 | 6 < TTL/BFL < 8 | 7.006 | 7.016 | 6.597 |
| 37 | 0.1 < F/TTL < 1 | 0.809 | 0.815 | 0.820 |
| 38 | 3 < F/BFL < 8 | 5.669 | 5.718 | 5.413 |
| 39 | 1 < F/ImgH < 3 | 1.075 | 1.083 | 1.090 |

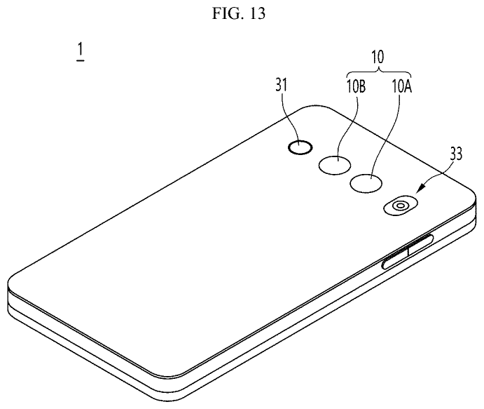

Table 17 shows the result values of Equations 1 to 39 described above in the optical system 1000 according to the first to third embodiments. Referring to Table 7, it may be seen that the optical system 1000 according to the first embodiment satisfies at least one or two or more of Equations 1 to 39. In detail, it may be seen that the optical system 1000 according to the first to third embodiments satisfies all of Equations 1 to 39 above. Accordingly, the optical system 1000 according to the first embodiment may have good optical performance and excellent optical properties at the center portion and periphery portion of the field of view (FOV). FIG. 13 is a diagram illustrating that a camera module according to an embodiment is applied to a mobile terminal. Referring to FIG. 13, the mobile terminal 1 may include a camera module 10 provided on the rear side. The camera module 10 may include an image capturing function. Also, the camera module 10 may include at least one of an auto focus function, a zoom function, and an OIS function. The camera module 10 may process a still video image or an image frame of a moving image obtained by the image sensor 300 in an imaging mode or a video call mode. The processed image frame may be displayed on a display unit (not shown) of the mobile terminal 1 and may be stored in a memory (not shown). In addition, although not shown in the drawings, the camera module may be further disposed on the front of the mobile terminal 1.

For example, the camera module 10 may include a first camera module 10A and a second camera module 10B. In this case, at least one of the first camera module 10A and the second camera module 10B may include the above-described optical system 1000 and the image sensor 300. In addition, the camera module 10 may have a slim structure and may have improved distortion and aberration characteristics. the camera module may be provided more compactly by the optical system 1000 having a slim structure. In addition, the camera module 10 may have good optical performance even at the center and the periphery portions of the field of view (FOV). The mobile terminal 1 may further include an autofocus device 31. The auto focus device 31 may include an auto focus function using a laser. The auto focus device 31 may be mainly used in a condition in which the auto focus function using the image of the camera module 10 is deteriorated, for example, in proximity of 10 m or less or in a dark environment. The autofocus device 31 may include a light emitting unit including a vertical cavity surface emission laser (VCSEL) semiconductor device and a light receiving unit that converts light energy such as a photodiode into electrical energy. The mobile terminal 1 may further include a flash module 33. The flash module 33 may include a light emitting device emitting light therein. The flash module 33 may be operated by a camera operation of a mobile terminal or a user's control.

Features, structures, effects, etc. described in the above embodiments are included in at least one embodiment of the invention, and are not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It can be seen that various modifications and applications that have not been made are possible. For example, each component specifically shown in the embodiment can be implemented by modification. And the differences related to these modifications and applications should be construed as being included in the scope of the invention defined in the appended claims.

1. An optical system comprising:
first to ninth lenses disposed along an optical axis in a direction from an object side to a sensor side,
wherein the first lens has a positive (+) refractive power on the optical axis,
wherein the second lens has a negative (−) refractive power on the optical axis,
wherein the eighth lens has a positive (+) refractive power on the optical axis,
wherein the ninth lens has a negative (−) refractive power on the optical axis,
wherein each of the first to ninth lenses has an object-side surface and a sensor-side surface,
wherein the sensor-side surface of the eighth lens has a convex shape on the optical axis,
wherein the object-side surface of the third lens has a concave shape on the optical axis,
L7_CT is a thickness on the optical axis of the seventh lens,
L8_CT is a thickness on the optical axis of the eighth lens, and
wherein the following equation satisfies:
$$0.1 < L7\_CT / L8\_CT < 0.8 . \qquad Equation$$

2. The optical system of claim 1,
F means a total focal length (mm) of the optical system, and f1 means the focal length (mm) of the first lens,
wherein the following equation satisfies:
$$0.5 < fl / F < 2. \qquad Equation$$

3. The optical system of claim 1,
L8_CT is the thickness on the optical axis of the eighth lens,
L8_ET is a thickness in a direction of the optical axis at an end of an effective region of the eighth lens,
wherein the following equation satisfies:
$$0.2 < L8\_ET / L8\_CT < 0.8 . \qquad Equation$$

4. The optical system of claim 3,
wherein the sensor-side surface of the eighth lens has a convex shape on the optical axis.

5. The optical system of claim 1,
wherein an object-side surface of the first lens has a convex shape on the optical axis, and
wherein a sensor-side surface of the second lens has a concave shape on the optical axis.

6. An optical system comprising:
first to ninth lenses disposed along an optical axis in a direction from an object side to a sensor side,
wherein the first lens has a positive (+) refractive power on the optical axis,
wherein the second lens has a negative (−) refractive power on the optical axis,
wherein the eighth lens has a positive (+) refractive power on the optical axis,
wherein the ninth lens has a negative (−) refractive power on the optical axis,
wherein each of the first to ninth lenses has an object-side surface and a sensor-side surface,
wherein the sensor-side surface of the eighth lens has a convex shape on the optical axis,
wherein the object-side surface of the third lens has a concave shape on the optical axis,
wherein the sensor-side surface of the ninth lens includes a first critical point, and
wherein the first critical point is disposed in a range of about 40% to about 60% of an effective radius of the sensor-side surface of the ninth lens with respect to the optical axis.

7. The optical system of claim 6,
wherein an object-side surface of the seventh lens includes a second critical point,
wherein the second critical point is disposed in a range of 60% to 80% of an effective radius of the object-side surface of the seventh lens with respect to the optical axis.

8. The optical system of claim 7,
wherein a sensor-side surface of the seventh lens includes a third critical point,
wherein the third critical point is disposed in a range of 55% to 75% of an effective radius of the sensor-side surface of the seventh lens with respect to the optical axis.

9. The optical system of claim 8,
wherein a distance from the optical axis to the first critical point is smaller than a distance from the optical axis to the second critical point.

10. An optical system comprising:
first to ninth lenses disposed along an optical axis in a direction from an object side to a sensor side,
wherein the first lens has a positive (+) refractive power on the optical axis,
wherein the second lens has a negative (−) refractive power on the optical axis,
wherein the eighth lens has a positive (+) refractive power on the optical axis,
wherein the ninth lens has a negative (−) refractive power on the optical axis,
wherein each of the first to ninth lenses has an object-side surface and a sensor-side surface,
wherein the sensor-side surface of the eighth lens has a convex shape on the optical axis,
wherein the object-side surface of the third lens has a concave shape on the optical axis,
wherein the sixth and seventh lenses are spaced apart by a first distance in a direction of the optical axis,
wherein the first distance increases from the optical axis toward a first point located on the sensor-side surface of the sixth lens, and decreases from the first point toward a second point located on the sensor-side surface of the sixth lens, and
wherein the second point is disposed further outside the first point with respect to the optical axis.

11. The optical system of claim 10,
wherein the first point is disposed in a range of 65% to 85% of an effective radius of the sensor-side surface of the sixth lens with respect to the optical axis.

12. The optical system of claim 10,
wherein the second point is an end or edge of an effective region of the sensor-side surface of the sixth lens.

13. The optical system of claim 10,
wherein the seventh and eighth lenses are spaced apart by a second distance in the direction of the optical axis, and
wherein the second distance decreases from the optical axis toward a third point located on a sensor-side surface of the seventh lens.

14. The optical system of claim 13,
wherein the third point is an end of an effective region of the sensor-side surface of the seventh lens.

15. The optical system of claim 10,
wherein the eighth and ninth lenses are spaced apart by a third distance in the direction of the optical axis,
wherein the third distance increases from the optical axis toward a fourth point located on a sensor-side surface of the eighth lens, and decreases from the fourth point toward a fifth point located on the sensor-side surface of the eighth lens, and
wherein the fifth point is disposed more outside than the fourth point with respect to the optical axis.

16. The optical system of claim 15,
wherein the third distance increases from the fifth point to a sixth point located on the sensor-side surface of the eighth lens, and
wherein the sixth point is an end of an effective region of the sensor-side surface of the eighth lens.

17. A camera module comprising:
an optical system and an image sensor;
wherein the optical system comprises the optical system according to claim 1,
TTL (Total Track Length) means a distance on the optical axis from a vertex of an object-side surface of the first lens to an upper surface of the image sensor, and
wherein the following equation satisfies:
$$2 < TTL < 20. \qquad Equation$$
